(19) United States
(12) Patent Application Publication
(10) Pub. No.: US 2025/0342133 A1
(43) Pub. Date: Nov. 6, 2025

(54) IN-BAND DATA PACKAGE TRANSMISSION

(71) Applicant: Kandou Labs SA, Saint-Sulpice (CH)

(72) Inventors: Subhash Roy, Saint-Sulpice (CH); Peter Korger, Saint-Sulpice (CH); Alexander Koch, Saint-Sulpice (CH); Jon Kenneth Nicoll, Saint-Sulpice (CH)

(73) Assignee: Kandou Labs SA, Saint-Sulpice (CH)

(21) Appl. No.: 19/128,121

(22) PCT Filed: Nov. 7, 2023
(86) PCT No.: PCT/US2023/078924

§ 371 Date: May 7, 2025

Related U.S. Application Data
(60) Provisional application No. 63/382,651, filed on Nov. 7, 2022.

(51) Int. Cl. G06F 13/40

(52) U.S. Cl. CPC G06F 13/4045; G06F 2213/0026

(57) ABSTRACT

Techniques for updating message definitions used by a PCIe component such as a retimer are described. The message definitions are provided within a firmware image that is checked for validity and authenticity during a firmware update process. This enables in-field updating of the message definitions in a secure manner, making it possible to securely expand or adjust the functionality offered by the component deployed in the field. In the case where the component is a retimer, the functionality can include delay buffer and/or lane routing settings that result in a reduced lane-to-lane skew. Techniques for in-band transmission of a data package such as a firmware update are also described.

### CROSS-REFERENCE TO RELATED APPLICATIONS

This application claims the benefit of U.S. Provisional Application No. 63/382,651, entitled “SECURE UPDATE OF FIRMWARE INCLUDING VENDOR-DEFINED INSTRUCTION DEFINITION”, filed Nov. 7, 2022, which is hereby incorporated by reference in its entirety for all purposes.

### REFERENCES

The following references are herein incorporated by reference in their entirety for all purposes:
PCI Express Base Specification Revision 6.0.1, Version 1.0, Sep. 13, 2022, accessible at pcisig [dot] com/specifications (referred to herein as [PCIe Specification].
PCI Express Retimer Test Specification Revision 4.0, Version 1.0, Jun. 10, 2022, accessible at pcisig [dot] com/specifications.
U.S. application Ser. No. 13/895,206, filed May 15, 2013, which granted as U.S. Pat. No. 9,288,082 on Mar. 15, 2016, entitled “Circuits for Efficient Detection of Vector Signaling Codes for Chip-To-Chip Communication Using Sums of Differences”, naming Roger Ulrich and Peter Hunt (referred to herein as [Ulrich]).

### BACKGROUND

As signals propagate over wires, they tend to degrade—that is, the signal to noise ratio decreases. This attenuation of a signal is often measured in decibels (dB) and tends to increase with the length of the wire that the signal is transmitted over.

Many electronics standards define a maximum loss for signals transmitted between an upstream component and a downstream component. For example, the Peripheral Component Interconnect Express (PCIe) 5.0 standard gives a-36 dB loss budget at 16 GHz for transmission from an upstream component (typically a root complex or switch) to a downstream component (typically an endpoint or switch). Failure to comply with this loss budget results in non-compliance with the standard, which is undesirable. However, it can be difficult to meet a loss budget in practice, particularly in the case of longer wires and higher data rates.

To resolve this issue, a retimer can be used. A retimer is a component that is located in the signal path between the upstream component and the downstream component. The retimer breaks the link between the upstream component and downstream component into two entirely separate links. The retimer is configured to condition the signal it receives via an upstream pseudo-port before transmitting the conditioned signal out via a downstream pseudo-port. Typically, a retimer equalizes the incoming signal and recovers the clocking of the incoming signal, such that the output of the retimer is a high amplitude, low noise and low jitter signal. A retimer can thus significantly reduce the total losses between the upstream and downstream components, bringing a previously non-compliant link within specification.

### BRIEF DESCRIPTION

In some circumstances an update of the firmware of a retimer is performed, e.g. to introduce new functionality. However, a firmware update process represents a risk in the sense that loading corrupt or unofficial firmware could cause the retimer to behave in a manner that is undesirable. Unofficial firmware could be loaded as the result of a deliberate attempt to cause the retimer to act in a manner that is not in accordance with manufacturer and/or customer specifications, i.e. hacking the retimer.

Techniques for updating message definitions used by a retimer are described. The message definitions are provided within a firmware image that is checked for validity and authenticity during a firmware update process. This enables in-field updating of the message definitions in a secure manner, making it possible to securely expand or adjust the functionality offered by a retimer deployed in the field. The messages themselves can be used to send in-band instructions, control information, data packages such as a firmware update, and the like to the retimer, or to trigger reception of a data package via transport layer packets.

An embodiment provides a Peripheral Component Interconnect express (PCIe) retimer, comprising: one or more Physical Layer Circuits (PHYs) configured to receive a PCIe data stream; a symbol detector configured to detect an in-band retimer message embedded in one or more control symbols within the PCIe data stream; and data package extraction logic configured to, responsive to the in-band retimer message, monitor the PCIe data stream subsequent to the in-band retimer message to detect a plurality of data package bits and write the data package bits to a memory of the retimer.

Another embodiment provides a method, comprising: receiving, by one or more Physical Layer Circuits (PHYs) of a Peripheral Component Interconnect express (PCIe) retimer, a PCIe data stream; detecting, by a symbol detector of the PCIe retimer, an in-band retimer message embedded in one or more control symbols within the PCIe data stream; monitoring, by data package extraction logic of the PCIe retimer and responsive to the detecting of the in-band retimer message, the PCIe data stream to detect a plurality of data package bits; and writing, by the data package extraction logic, the plurality of data package bits to a memory of the retimer.

### BRIEF DESCRIPTION OF FIGURES

FIG. 1 is a block diagram of a retimer suitable for implementing embodiments described herein.

FIG. 2 is a block diagram of a single tile retimer suitable for implementing embodiments described herein.

FIG. 3 is a schematic drawing of contents of a memory external to a retimer, which memory can hold a data package for writing to components of the retimer.

FIG. 4 is a block diagram of a two-tile retimer suitable for implementing embodiments described herein.

FIG. 5 is a block diagram of the follower tile of the two-tile retimer of FIG. 4.

FIG. 6 is a block diagram of a four-tile retimer suitable for implementing embodiments described herein.

FIG. 7A is a block diagram of a PCIe lane switching multiplexer and accompanying circuitry that can form part of a retimer suitable for implementing embodiments described herein.

FIG. 7B shows a loopback configuration of the multiplexer of FIG. 7A.

FIG. 7C shows a first retimer configuration of the multiplexer of FIG. 7A.

FIG. 7D shows a second retimer configuration of the multiplexer of FIG. 7A.

FIG. 8A shows the format for a header of a PCIe vendor defined message packet.

FIG. 8B is a block diagram of retimer components capable of detecting and acting on a vendor-defined message.

FIG. 8C is a schematic diagram of a PCIe data stream using a technique based on control skip ordered sets capable of transporting a data package in-band, according to an embodiment.

FIG. 8D is a schematic diagram of a PCIe data stream using a technique based on training ordered sets capable of transporting a data package in-band, according to an embodiment.

FIG. 8E is a schematic diagram of a PCIe data stream using a technique based on control skip ordered sets and transport layer packets capable of transporting a data package in-band, according to an embodiment.

FIG. 8F is a flow diagram of a process for transmitting a data package in-band over a PCIe link, according to an embodiment.

FIG. 9 is a flow diagram of a first process for securely updating the firmware of a retimer to provide new vendor defined message definitions, according to an embodiment.

FIG. 10A shows in schematic form the content of a firmware image used in the process of FIG. 9.

FIG. 10B is a flow diagram showing one way of authenticating a firmware image using firmware authentication information, as part of the process of FIG. 10.

FIG. 11 shows in schematic form the content of a first firmware image block and a subsequent firmware image block used in the process of FIG. 12.

FIG. 12 is a flow diagram of a second process for securely updating the firmware of a retimer to provide new vendor defined message definitions, according to an embodiment.

FIG. 13 is a flow diagram providing further detail of the step of validating a block in FIG. 12.

FIG. 14 is a flow diagram providing further detail of the step of storing a block in a non-volatile memory in FIG. 12.

FIG. 15 is a block diagram of a pair of retimers performing a link deskew operation, according to an embodiment.

### DETAILED DESCRIPTION

At times in this specification reference is made to the Peripheral Component Interconnect Express (PCIe) standard. This is to assist in the understanding of this disclosure by describing certain features in the context of a particular standard. However, it should be appreciated that, unless expressly stated otherwise, teaching herein has applicability outside of the PCIe standard.

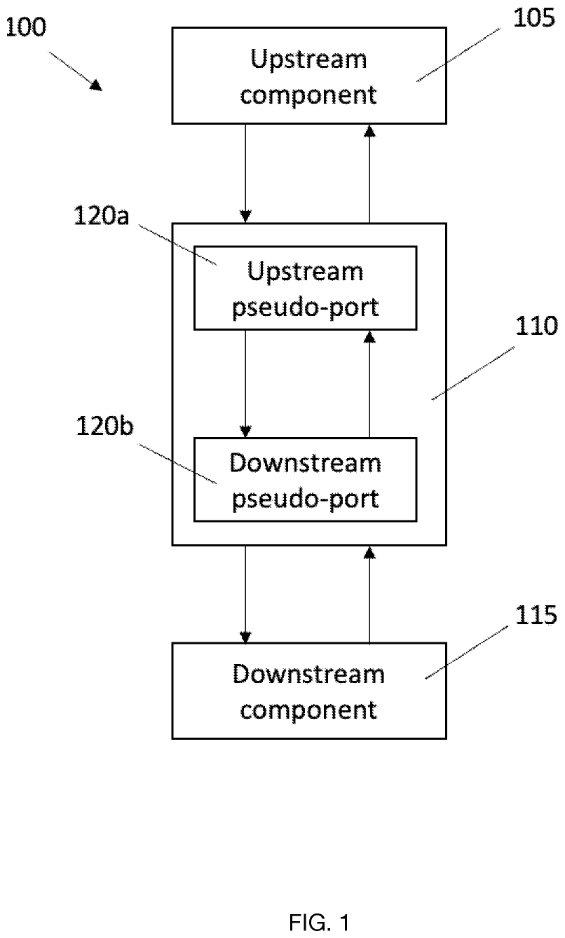

FIG. 1 shows in schematic form a system 100 incorporating a retimer 110. Retimer 110 is coupled to an upstream component 105 that is typically a root complex or a switch. This coupling is via upstream pseudo-port 120a of retimer 110. Similarly, retimer 110 is coupled via downstream pseudo-port 120b to a downstream component 115, typically a switch or endpoint. In this disclosure, physical layer entities such as pseudo-ports may be alternatively referred to as PHYS.

It is thus apparent from FIG. 1 that retimer 110 functions to divide a link between upstream component 105 and downstream component 115 into two parts. Retimer 110 is configured to condition the signal received via upstream pseudo-port 120a and to provide a clean signal with low jitter and good signal to noise ratio as an output of downstream pseudo-port 120b. Retimer 110 is bi-directional, and thus is also capable of conditioning a signal received as an input to downstream pseudo-port 120b. In this case, the clean output signal would be sent out via upstream pseudo-port 120a.

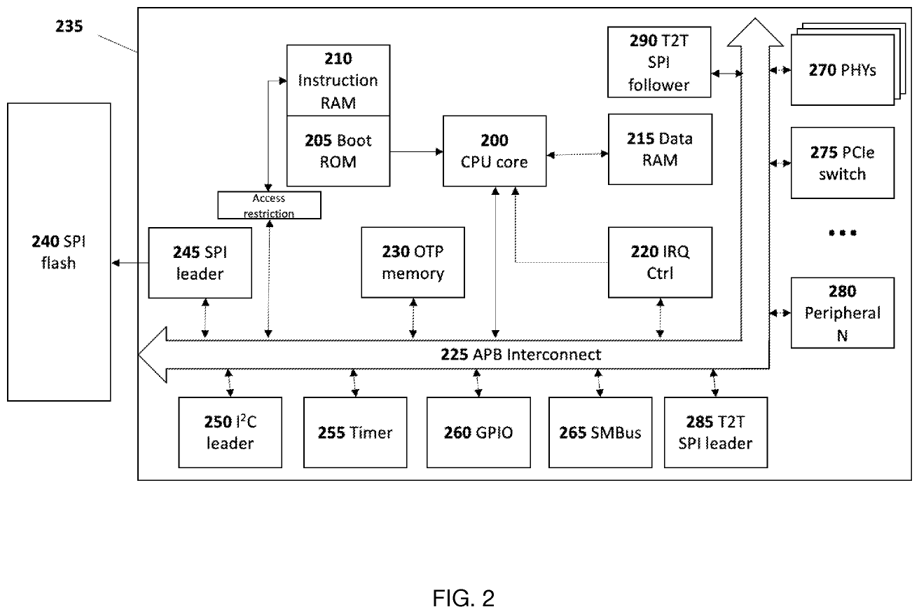

FIG. 2 shows retimer 110 in schematic form in additional detail. For ease of understanding, some components of retimer 110 have been omitted.

Retimer 110 includes a CPU core 200, also referred to herein as a processor. CPU core 200 is configured to perform various tasks to support the function of retimer 110. One such task is the loading of firmware from an external non-volatile memory to boot ROM 205 during a boot process. CPU core 200 acts in accordance with instructions stored in instruction RAM 210 and operates on data stored in data RAM 215. CPU core 200 is also coupled to interrupt request (IRQ) controller 220 to enable CPU core 200 to receive interrupt requests from other components of retimer 100 or from external components.

CPU core 200 is also coupled to Advanced Peripheral Bus (APB) interconnect 225. The APB interconnect enables CPU core 200 to communicate with other components of retimer 110 that are coupled to this bus-reference is made to FIG. 2 in this regard. It will be appreciated that APB interconnect 225 can be replaced with an alternative bus, e.g. AHB, without departing from the scope of this disclosure.

APB interconnect 225 also enables other components of retimer 110 to communicate with instruction ram 210 directly in a controlled manner (see ‘access restriction’ in FIG. 2). This ensures that only components that should be able to access instruction ram 210 can do so, and further that instructions that any such components place in instruction ram 210 are legitimate.

Retimer 110 also includes a non-volatile read-only memory that could be a one-time programmable (OTP) memory 230 as shown in FIG. 2. Other forms of non-volatile ROM could alternatively be used. OTP memory 230 stores, among other things, a public key, or hash of a public key, that is usable by CPU core 200 to check that firmware is genuine before it is executed by CPU core 200. More information is provided on this firmware validation process later.

The read-only memory can additionally store information such as boot mode data indicating the mode in which the retimer should boot and/or configuration data, e.g. initialisation values for registers of the retimer. A unique identifier for the retimer could additionally or alternatively be stored in the read-only memory. Other such information could additionally or alternatively be stored in the read-only memory.

Firmware is loaded from an external non-volatile memory. Here, ‘external’ refers to the memory being located off-die, i.e. it is not part of the die 235 that CPU core 200 is part of. In the illustrated embodiment the external non-volatile memory is a SPI flash memory 240. CPU core 200 communicates with SPI flash 240 via an SPI bus, with the corresponding SPI leader 245 being connected to APB interconnect 225 to provide the complete communication channel between CPU core 200 and SPI flash 240. This configuration is provided as an example and is not the only possible configuration. For example, external non-volatile memory could instead be an EEPROM and in that case CPU core 200 could communicate with the EEPROM via an I²C bus (see I²C bus leader 250 in FIG. 2) that is coupled to APB interconnect 225. Further variations are possible, and it should be understood that any variation that enables CPU core 200 to communicate with the external non-volatile memory is within the scope of this disclosure.

It is noted that the PCIe standard as applicable to retimers requires an I²C bus to be present. However, it has been recognised that I²C is a relatively slow interface such that problems can arise when loading firmware from the external memory. Specifically, an I²C bus and EEPROM may make it difficult to meet certain timing requirements of the PCIe specification. For this reason, a SPI bus and SPI flash 240 can be used to significantly reduce firmware loading times by virtue of the fact that an SPI interface offers a higher data transfer rate than an I²C interface. Given this, it is contemplated that in some implementations the I²C bus could be omitted entirely.

Retimer 110 also includes timer 255, general purpose input/output pin(s) (GPIO) 260 and system management bus (SMBus) 265. These components are all coupled to APB interconnect 225 to facilitate communication with other components of retimer 110.

Timer 255 provides a programmable timing capability, e.g. to allow the performance of periodic tasks between which a low power state may be entered. GPIO 260 provides one or more general purpose pins that are unused by default, but which may be controlled by software to be used in some manner, e.g. to extend the functionality of retimer 110 in some way. SMBus 265 provides a facility for communicating information (e.g. status, configuration, device name, type, etc.) about devices coupled to retimer 110 and also for transmitting commands to said devices. One or more of timer 255, GPIO 260 and SMBus 265 could be omitted, or replaced with another component of similar functionality, without departing from the scope of this disclosure.

Retimer 110 further includes one or more physical layer components (PHYs) 270. These represent physical-layer components, e.g. a serializer/deserializer (SerDes). PHYs 270 are coupled to APB interconnect 225 to provide a communication path to CPU core 200, as well as any other component of retimer 110 also coupled to APB interconnect 225. One or more PHYs 270 may require CPU core 200 to initialise them, e.g. by providing firmware. This could be loaded by CPU core 200 from SPI flash 240, for example.

Retimer 110 additionally includes a PCIe switch 275 that is coupled to APB interconnect 225. PCIe switch 275 implements PCIe switching functionality as defined by the relevant part of the PCIe standard. This enables retimer 110 to operate in a PCIe switching mode if desired. It will be appreciated that PCIe switch 275 can be omitted in the case where it is not necessary for retimer 110 to provide a PCIe switching capability.

FIG. 2 includes a placeholder ‘peripheral N’ 280 that is coupled to APB interconnect 225 to illustrate that retimer 110 is not limited to the specific set of peripherals illustrated in FIG. 2. Additional peripherals coupled to APB interconnect 225 may be added to retimer 110 as desired. Examples include: one or more PCIe Compute Express Links (CXLs), Physical Coding Sublayer (PCS) components, a packet inspecting component, a Joint Test Action Group (JTAG) interface, and/or a high-speed die-to-die interface as described in [Ulrich]. Peripheral N 280 represents any number of such additional peripherals, including none.

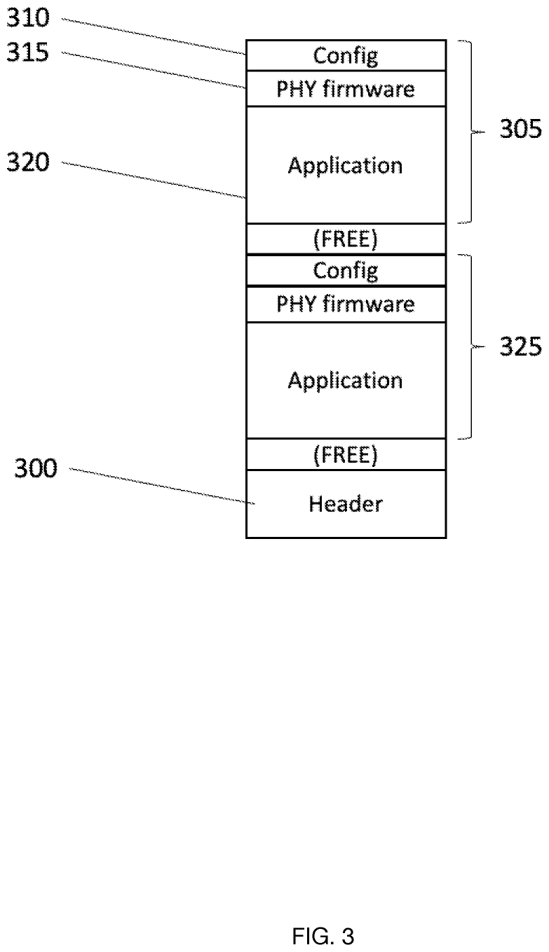

FIG. 3 shows one set of possible contents for SPI flash 240. Many variations are possible and it should thus be understood that FIG. 3 is provided with a view to assisting in the understanding of this disclosure rather than restricting its scope.

SPI flash 240 is split into two regions (a.k.a. partitions)—an active region and an inactive region. Each region corresponds to a set of addresses in SPI flash 240. These addresses do not necessarily need to be continuous-indeed, as illustrated in FIG. 3, they can be interposed between one another. An active region refers to a set of memory addresses that hold information that will be used by CPU core 200 on next boot whereas an inactive region refers to a set of memory addresses that hold information that will not be used by CPU core 200 on next boot. The purpose of this partitioning is to allow updated firmware to be stored in the inactive region without disrupting the operation of the active region. This means that, in the event the updated firmware image is not usable (e.g. it is corrupt or invalid), the retimer can still boot from the existing firmware image stored in the active region.

The active and inactive statuses are set by one or more flags that are stored in header 300. Header 300 can store any other information that is deemed to be useful, such as the size of each memory region in bits, a starting address of each region, a date on which the SPI flash was last updated, a firmware version, and the like.

The active region includes an active firmware image 305. This is the firmware image that will be used by CPU core 200 the next time retimer 110 is booted. Active firmware image 305 includes a configuration file 310, PHY firmware 315 and an application 320. It will be appreciated that this is just one example and that active firmware image 305 could alternatively include different information, or additional information, to that shown in FIG. 3.

Configuration file 310 stores information that is used by CPU core 200 during a boot process to configure retimer 110. For example, configuration file 310 could include one or more values that are to be respectively written to one or more registers of retimer 110 during the boot process. Protocol-specific information can be stored in configuration file 310, such as one or more PCIe vendor-defined message definitions. Updating the configuration file 310, e.g. as part of a firmware update process, thus enables the vendor-defined message definitions to be updated. This can enable retimer 110 to offer new functionality after a firmware update has taken place. More information is provided on this later.

PHY firmware 315 is essentially a smaller firmware image within active firmware image 305. PHY firmware 315 is used to initialise PHYs 270, e.g. CPU core 200 provides PHY firmware 315 to each of PHYs 270 during a boot process. It will be appreciated that PHY firmware 315 can be omitted in the case where there are no PHYs requiring firmware on boot. When present, PHY firmware 315 provides a convenient and secure channel for updating the firmware of PHYs 270 because a new firmware image with updated PHY firmware can be loaded into SPI flash 240.

Application 320 is an executable file that is run by CPU core 200 to enable it to boot correctly. During boot, application 320 is loaded by CPU core 200 and executed once loaded, assuming all security checks are passed successfully. Further information on the security checks performed to authenticate application 320, and more generally active firmware image 305, is provided later in this specification.

Active firmware image 305 also includes a second stage bootloader (not shown). The second stage bootloader is an application that handles loading of certain items such as a real-time operating system (RTOS), to assist application 320. The second stage bootloader can be omitted if not needed.

Inactive firmware image 325 is a copy of active firmware image 305. It also includes a configuration file, PHY firmware and an application as described above. Inactive firmware image 325 can differ from active firmware image 305 in aspects such as firmware version—e.g. the PHY firmware, configuration file and/or application in inactive firmware image 325 can be a different version than its counterpart in the active firmware image 305.

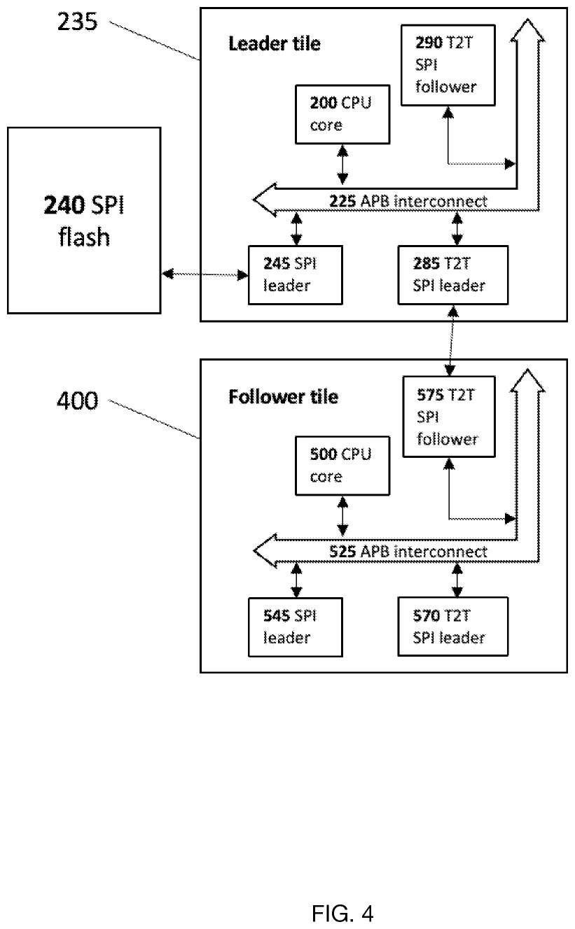

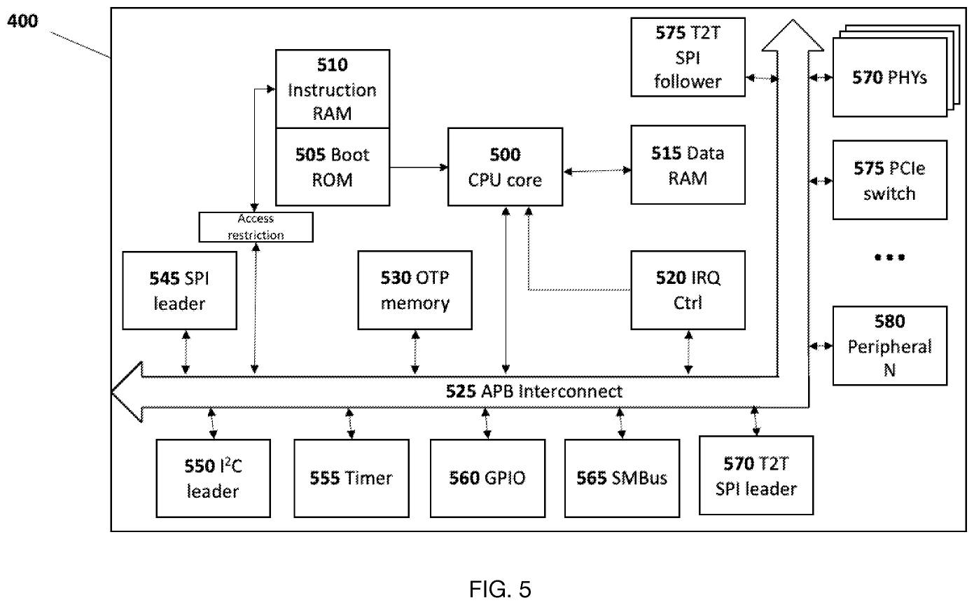

Thus far the discussion has been restricted to a single-tile configuration, in which the components of retimer 110 are located on a single die 235 (other than SPI flash 240 which is external to the die). FIGS. 4 and 5 show a multi-tile configuration in which a second tile is introduced. The components of the second tile are located on a separate, second die 400. As shown in FIG. 5, the components of the second tile are largely identical to those of the first tile and have been given reference signs with identical suffix to those of FIG. 2 to reflect this. Reference is thus made to the preceding discussion in this regard.

The first tile is referred to herein as the leader tile (a.k.a. master tile) and the second tile is referred to herein as the follower tile (a.k.a. slave tile). A distinction between the leader tile and follower tile in many embodiments is that the majority of the components on the follower tile are inactive. Specifically, in one embodiment, the following components are inactive on the follower tile: CPU core 500, boot ROM 505, instruction RAM 510, data RAM 515, IRQ controller 520, OTP memory 530, SPI leader 545, I²C leader 550, timer 555, GPIO 560, SMBus 565 and T2T SPI leader 575. These components are present as it is easier from a manufacturing perspective to produce identical tiles and designate one as leader and the other as follower. However, alternatively the above-mentioned components could be omitted. Similarly, the leader tile includes both T2T SPI leader 285 and T2T SPI follower 290, with only the T2T SPI leader 285 being active. As noted above, alternative non-identical manufacture is possible in which only the T2T leader is present on the leader tile and only the T2T follower is present on the follower tile. Further, during die testing, certain die defects that affect leader tile functions/circuits might nonetheless be deemed acceptable for a die to act as a follower tile, thus increasing production yield percentages.

It is also pointed out that there is no SPI flash (or other external memory) coupled to the follower tile. This is because only the leader tile CPU core 200 is active, hence there is no need to load firmware to inactive CPU core 500 of the follower tile.

The leader tile and follower tile communicate via a bus that spans both dies 235 and 400 (see FIG. 4). In the case of FIGS. 4 and 5 this bus is a SPI bus, but alternative bus types could be used in place of an SPI bus if desired.

To facilitate communication, the leader tile includes a tile-to-tile (‘T2T’) SPI bus leader 570 that is coupled to a corresponding T2T SPI bus follower 575 via wires extending between the leader and follower tiles. These wires could be circuit traces, for example. Collectively, the T2T SPI leader 285 and T2T SPI follower 575 are referred to herein as the ‘T2T SPI bus’. T2T SPI leader 285 is coupled to APB interconnect 225 on the leader tile to enable other components of the leader tile (e.g. CPU core 200) to communicate with T2T SPI leader 285. Similarly, T2T SPI follower 575 is coupled to APB interconnect 525 on the follower tile to enable communication with other components on the follower tile—e.g. PHYs 570, PCIe switch 575 and other peripherals 580. T2T SPI follower 575 is set as APB leader on APB interconnect 525 as the CPU core on the follower tile is inactive.

Remaining true to the principle of identical tiles, in FIGS. 4 and 5 both the T2T SPI leader 570 and T2T SPI follower 575 are shown on the follower tile. However, it should be appreciated that only T2T SPI follower 575 is active on the follower tile of FIG. 5. Similarly, the leader tile includes both T2T SPI leader 285 and T2T SPI follower 290, with only the T2T SPI leader 285 being active. As noted above, alternative non-identical manufacture is possible in which only the T2T leader is present on the leader tile and only the T2T follower is present on the follower tile.

The follower tile has its own set of PHYs 570, PCIe switch 575 and other peripherals 580. These are the same as the corresponding items shown on FIG. 2 and reference is thus made to the discussion above. PHYs 570, PCIe switch 575 and other peripherals 580 can be controlled by the CPU core 200 of the leader tile via the T2T SPI bus.

More than one bus can be present that spans both dies to provide multiple channels of communication between the dies. For example, a high-speed die-to-die SerDes-based interface as described in [Ulrich] could additionally be present. The high-speed interface described in [Ulrich] is a high bandwidth bus that enables relatively large volumes of data to be exchanged between the leader and follower tiles. Other bus types could additionally or alternatively be present, e.g. a Universal Chiplet Interconnect Express (UCIe) bus.

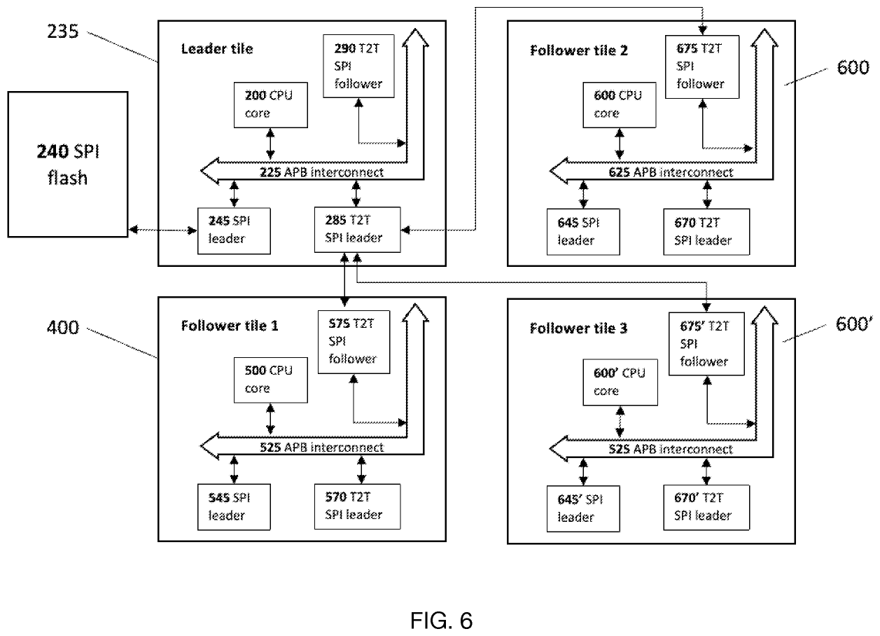

It is possible to extend the two-tile configuration discussed above to further tiles. A four-tile configuration is shown in FIG. 6. In this configuration there is one leader tile and three follower tiles (tiles 1, 2 and 3). Each of the four tiles is on its own die-leader tile is on die 235, follower tile 1 is on die 400, follower tile 2 is on die 600 and follower tile 3 is on die 600′. Each follower tile is the same as the follower tile shown in FIGS. 4 and 5 and as discussed above. The leader tile is the same as discussed above. T2T SPI leader 285 on the leader tile is coupled to the respective T2T SPI follower on each follower tile—i.e. T2T follower 575, 675 and 675′. This enables CPU core 200 to control any component on any of the follower tiles. Although not shown for clarity in FIG. 6, the leader tile and each follower tile has its own PHYs, PCIe switch and/or other peripherals of the type discussed above, which are all controllable by CPU core 200.

In the general case, it is possible to extend to N tiles with one leader and N-1 follower tiles coupled via an inter-tile bus like the T2T SPI bus described above.

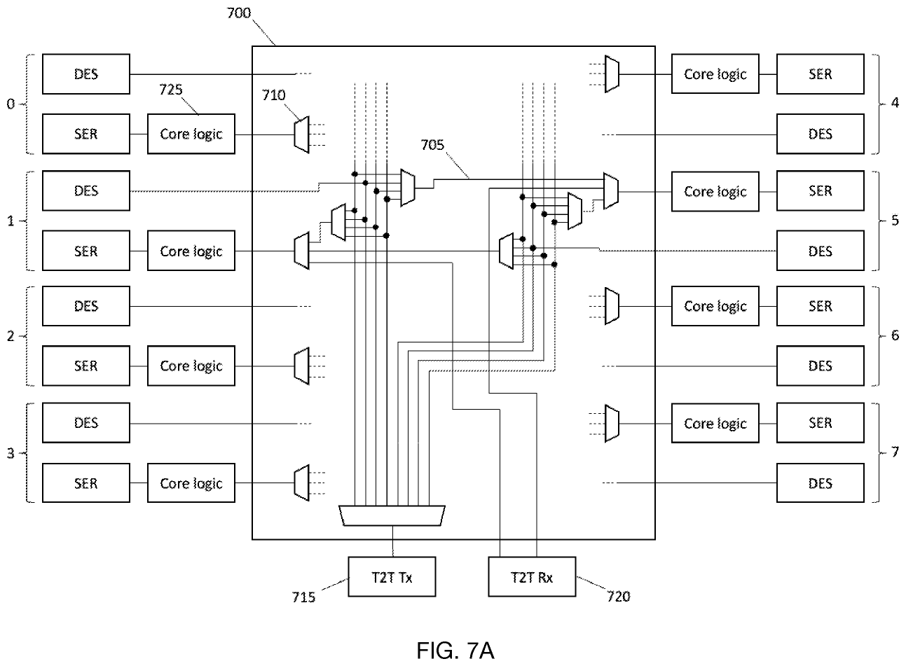

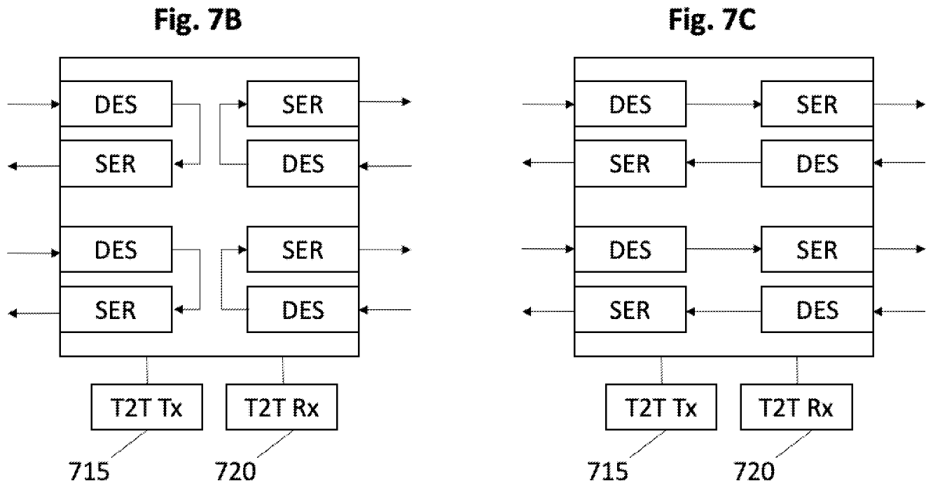

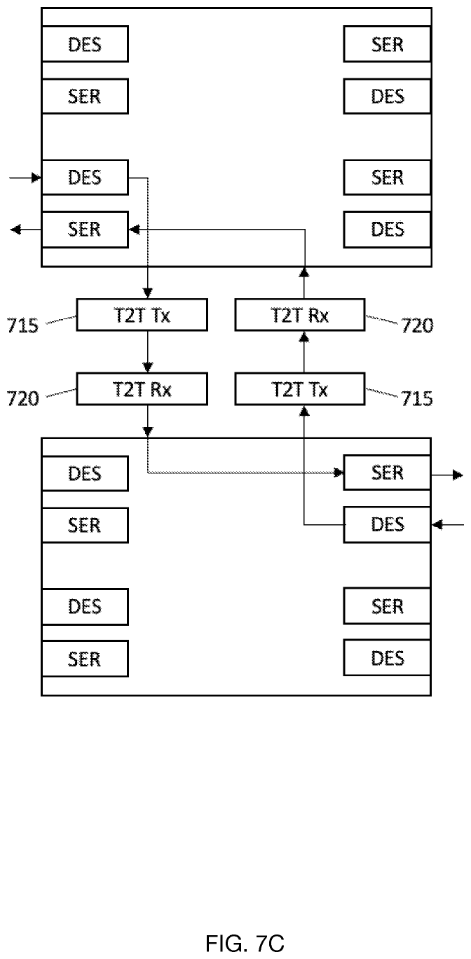

FIG. 7A shows a block diagram of a PCIe lane switching multiplexer (MUX) 700, which may also be referred to as a ‘crossbar switch’, and accompanying circuitry. MUX 700 is for lane routing in a retimer circuit die, including routing on a single die (e.g. leader tile 235) and routing to other dies/tiles in a multi-tile configuration. MUX 700 comprises a series of electrical connections 705 which are typically circuit traces and a number of multiplexers 710 coupled to electrical connections 705.

FIG. 7A shows just a subset of electrical connections 705 and multiplexers 710 to increase the intelligibility of the diagram. It will be appreciated that in practice each SER and DES is coupled to electrical connectors 705 in the way shown for pseudo-ports 1 and 5 in FIG. 7A. The other couplings are represented by dashed lines and are not shown in full in the interests of clarity.

Coupled to MUX 700 are a set of serializers (SER) and deserializers (DES). Each SER is paired with an accompanying DES to form a pseudo-port, numbered from 0 to 7 in FIG. 7A. Each SerDes pair/pseudo-port can be part of one of PHYs 270 (FIG. 2) in the case of a leader tile or part of one of PHYs 570 (FIG. 5) in the case of a follower tile. In FIG. 7A, eight pseudo-ports are provided (pseudo-ports 0 to 7), but this number is not to be construed as limiting as fewer or more pseudo-ports can alternatively be present. Each pseudo-port allows incoming traffic to enter MUX 700 (via the respective DES) and to exit MUX 700 (via the respective SER). A pair of coupled pseudo-ports carrying traffic between them can be referred to as a lane—e.g. traffic incoming via pseudo-port 0 and exiting via pseudo-port 7 is a lane carried by pseudo-ports 0 and 7. As MUX 700 allows any pseudo-port to communicate with any other pseudo-port and also itself, many different lane configurations are possible. As each pseudo-port comprises a SER and DES, simultaneous transmission and reception by a given pseudo-port (‘full duplex’ operation) is possible.

MUX 700 allows any pseudo-port it is coupled with to communicate with any other pseudo-port it is coupled with. That is, in FIG. 7A pseudo-port 0 can communicate with any of pseudo-ports 1 to 7, or with itself in a loopback-type configuration. The communication path is selected by controlling multiplexers 710 so as to route signals from a given pseudo-port to another pseudo-port.

In the case of a multi-tile retimer, MUX 700 can also enable communication with pseudo-ports on other tiles via tile-to-tile transmitter (T2T Tx) 715 and tile-to-tile receiver (T2T Rx) 720. T2T Tx 715 and T2T Rx 720 can be implemented via any interface that enables inter-tile communication, including the high-speed SerDes-based die-to-die interface disclosed in [Ulrich] or a UCIe interface. This expands the set of possible lanes from that discussed above to also encompass any pseudo-port on a first tile communicating with any pseudo-port on a second tile.

It will be appreciated that each tile in a multi-tile retimer includes a respective MUX like MUX 700 such that signals transmitted by T2T Tx 715 are received by a receiver on another tile that is like T2T Rx 720.

MUX 700 is controlled by CPU core 200 (or another bus leader, if present). Control messages can be in-band vendor-defined messages-more information is provided on this later. Switching a data path in MUX 700 can include switching a received data bus (e.g. a 32-bit bus) carrying deserialized lane-specific data words, accompanying data enabled lines, a recovered clock, and a corresponding reset. Only raw data is multiplexed, the received data is not processed in any way. The MUX logic can be statically configured via configuration bits, the switching itself happens asynchronously.

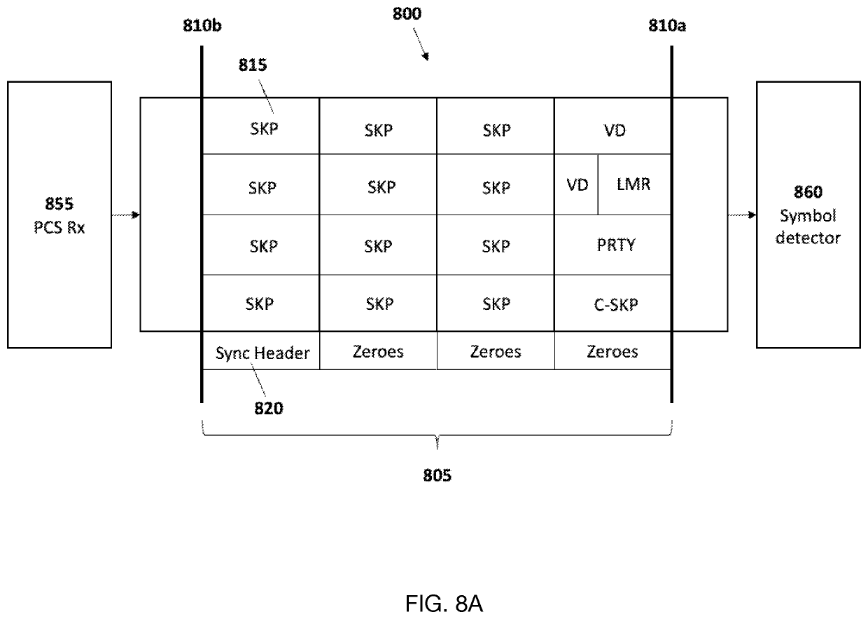

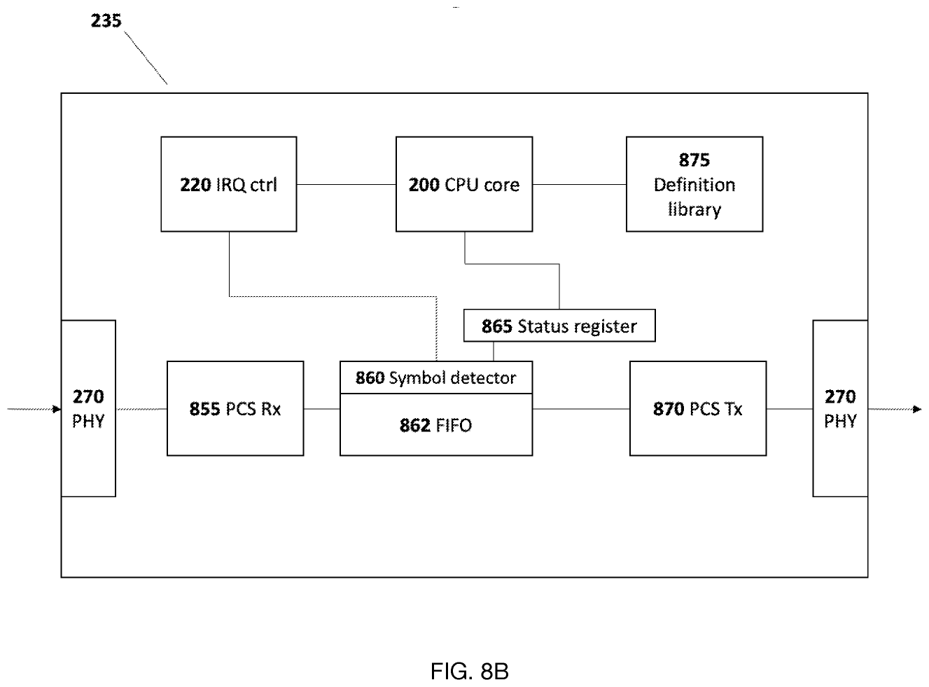

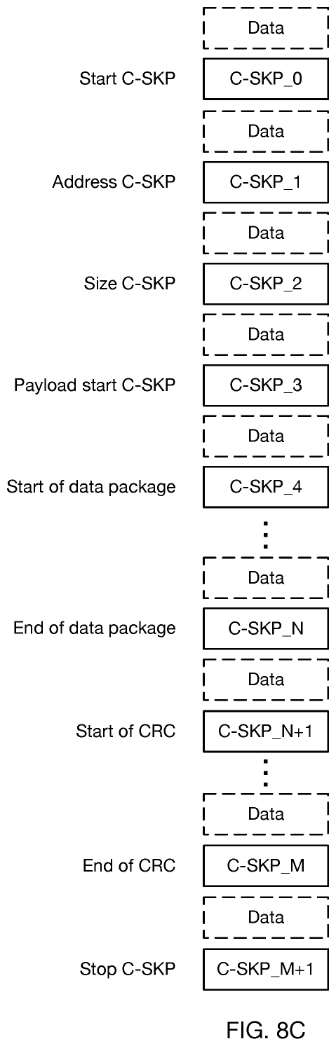

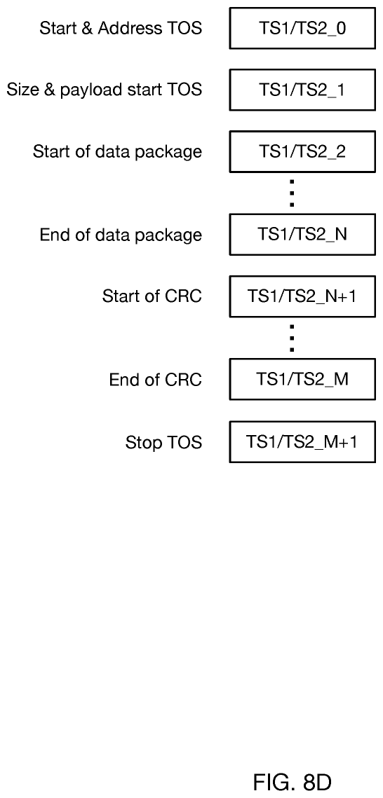

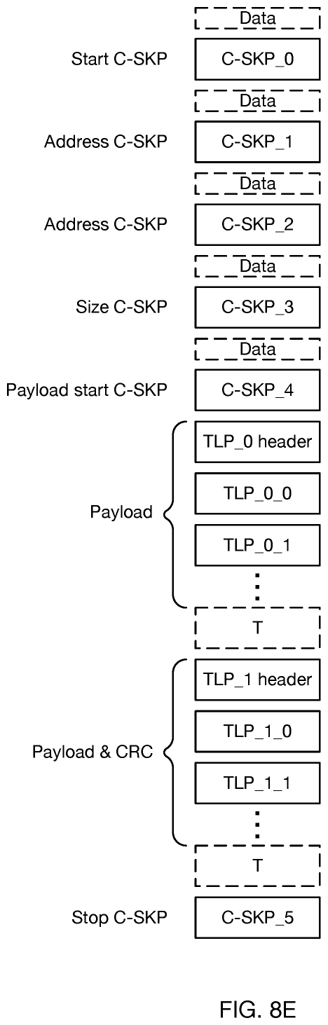

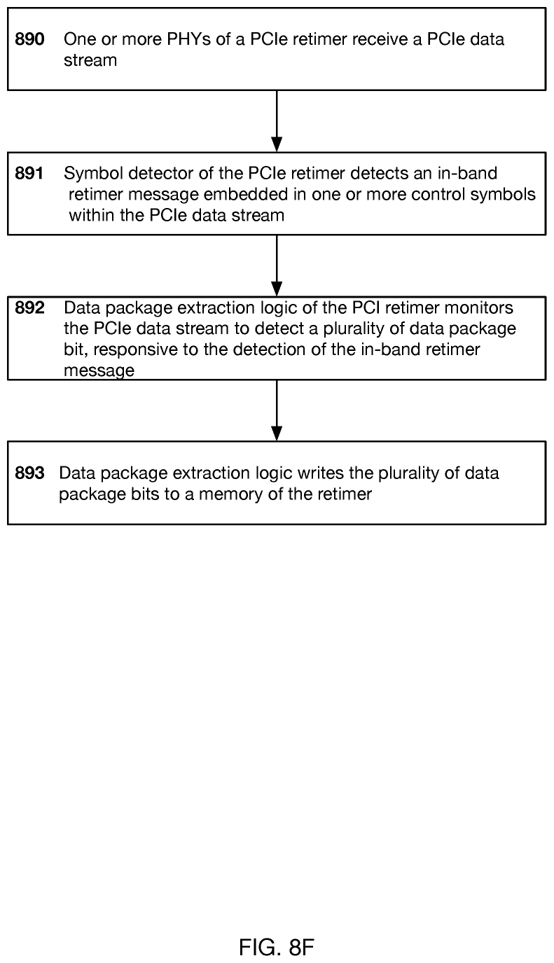

Each SER is coupled to respective core logic like core logic 725. Core logic 725 can include any logic necessary to enable retiming functionality to be carried out. Core logic 725 can include PCS RX 855, symbol detector 860 and status register 865 (FIG. 8B), for example.

FIGS. 7B to 7D show different possible signal paths that MUX 700 enables. FIGS. 7B and 7C route symbols between pseudo-ports on a single tile, whereas FIG. 7D shows multi-tile routing in which symbols on a first tile are routed to a pseudo-port on a second tile by MUX 700. Not all SerDes are shown in each of FIGS. 7B to D compared with FIG. 7A, for increased clarity. In each case the paths shown are enabled by a specific configuration of MUX 700. In the case of FIG. 7D, a second MUX like MUX 700 is present on the lower tile also. These signal paths are shown purely to assist in the understanding of the invention and it should be appreciated that other signals paths that are not shown are also possible.

FIG. 7B shows a signal path in which symbols are routed back out of the pseudo-port on which they entered MUX 700. This is a loopback or test mode that is useful for establishing that basic link functionality is working correctly. Two lanes are shown in FIG. 7B, but more could be present.

FIG. 7C shows a signal path in which symbols are routed between an upstream pseudo-port (on the left of the diagram) and a downstream pseudo-port (on the right of the diagram), where both upstream and downstream pseudo-ports are on the same tile. This is a retiming mode where the core logic shown in FIG. 7A performs retiming operations. Two lanes are shown in FIG. 8B, but more could be present.

FIG. 7D shows a signal path in which symbols are routed between an upstream pseudo-port (on the left of the diagram) and a downstream pseudo-port (on the right of the diagram), where the upstream pseudo-port is located on a different tile to the downstream pseudo-port. The T2T Tx 715 and T2T Rx 720 handle the inter-tile data transfer. This is another retiming mode where the core logic shown in FIG. 7A performs retiming operations. For clarity, just one lane is shown in FIG. 7D. The first and second tiles can be any of the tiles discussed herein, e.g. routing between a leader tile and a follower tile, or between two follower tiles.

The configurations shown in FIGS. 7B to 7D are not exhaustive and other configurations that are not shown are also within the scope of this disclosure.

FIG. 8A shows a possible technique for encoding control information in a data stream. In the illustrated embodiment, the data stream is a PCIe data stream and the control information takes the form of vendor-defined (‘VD’) commands. The VD commands are referred to herein as ‘VD instructions’, with it being understood that a VD scheme can define one or more VD instructions. These make use of the ‘vendor-defined message’ capabilities of the PCIe protocol. While this embodiment is PCIe specific, it will be appreciated that an equivalent mechanism provided by an alternative protocol can be used in place of the PCIe vendor-defined message capabilities.

For example, a VD scheme for switching an operating mode of a retimer from a ‘normal’ mode to a ‘low latency’ mode could include a VD instruction that includes a command to switch from the normal mode to the low latency mode.

As another example, a VD scheme for applying a lane routing configuration that reduces skew could include a VD instruction that includes a lane skew value or a pointer to a memory address storing a lane skew value.

As a further example, a VD scheme for providing an in-band data package transmission for the retimer could include a first VD instruction that marks the start of a data package being sent in-band to the retimer and a second VD instruction that marks the end of the data package. The data package could be updated firmware for the retimer, for example. More information is provided on this below.

These are just three possible examples—the scope of this disclosure is not limited to these examples.

FIG. 8A shows a decoded data stream 800 comprising multiple blocks. In FIG. 8A, a 128b130b encoding scheme is used, but this is not limiting as alternative encoding schemes could be used instead. Data stream 800 is output by a physical coding sublayer receiver (PCS Rx) 855 (see also FIG. 8B) and provided to a symbol decoder 860 (see also FIG. 8B) for detection of at least vendor-defined instructions. Each lane in a PCIe link has a respective data stream like data stream 800.

Block 805 is shown in detail as an illustrative example. Each block is bounded by block boundaries 810a, 810b. In this case as 128b130b encoding is used, block 805 is 136 bytes long (including all headers) or 130 bytes long (excluding all zeroed headers). Each column of FIG. 8 is a 34-bit data word (including headers, 32-bit data word excluding headers). Other block lengths and data word sizes can alternatively be used.

Block 805 is shown divided up into a plurality of symbols 815, in this case 16 symbols. Each symbol in this case is 8 bits (one byte), but other symbol sizes can be used. More information on the symbols used is given below.

Also present are sync header bits 820, in this case comprising two bits. Other sized sync headers can alternatively be used. The sync header 820 marks the start of block 805 and hence the symbols shown in FIG. 8 are in the order in data stream 800 given by reading bottom to top, left to right, starting with sync header 820. The final symbol at the end of the block is therefore the VD symbol located in the top right corner of block 805. An exemplary value for the sync header is ‘10’ (binary), although alternative values could be used. The value of the sync header 820 is used to distinguish blocks like 805 that contain control information from data blocks (not shown) that contain data. A data block has a different value for the sync header that marks the start of the data block, e.g. ‘01’ (binary).

As the sync header marks the start of block 805, the header of each subsequent data word within block 805 is set to a value that clearly distinguishes it from sync header 820. In this case the header of each subsequent data word within block 805 is set to a zero value, i.e. ‘00’ in this two-bit example. Other values can alternatively be used.

The symbols shown in FIG. 8A are discussed below. It will be appreciated that this list of symbols is non-exhaustive and other symbols can additionally or alternatively be present in block 805.

FIG. 8A shows PCIe gen 4/5 symbols. However, the format of the symbols can vary between different versions of a protocol, e.g. PCIe gen 5 symbols can differ from PCIe gen 6 symbols. This disclosure should be understood as not limiting to any particular version of a protocol, hence illustrations of a particular symbol corresponding to a particular version of a protocol should be understood as being present to assist in the understanding of the techniques described herein rather than limiting said techniques to the depicted symbols. In cases where a particular symbol from a first version of a protocol is not available in an alternate version of the protocol, or in a different protocol, it will be appreciated that the teaching herein can be adapted to make use of a symbol in the alternate version of the protocol, or different protocol, having the same or similar properties to the symbol used in the first version of the protocol.

SKP is a skip symbol. This symbol includes a value or set of values that is/are readily identifiable, e.g. ‘AA’ or ‘99’ (hexadecimal) in the case of 128b130b encoding (PCIe gen 4 and 5). Other values for the skip symbol could alternatively be used. The skip symbols are used in a rate adaptation process that is not described in detail here as it is not pertinent to this disclosure.

C-SKP is a control skip symbol. This symbol also includes a value or set of values that is readily identifiable and that is distinguishable from the skip symbol, e.g. ‘78’ (hexadecimal) or alternating patterns of ‘FOh’ and ‘0Fh’ in the case of 1b1b encoding (PCIe gen 6). Other values for the control skip symbol could alternatively be used. The presence of the control skip symbol signifies that block 805 is a ‘control skip ordered-set’, the significance of which here is that block 805 contains at least one VD instruction.

PRTY is a parity symbol that contains some parity information. This information is not pertinent to this disclosure and hence no further details are provided here.

‘VD’ in FIG. 8A is a byte storing a VD instruction or a part thereof. The value of a VD byte is selected according to the VD scheme that defines the VD instruction that the VD byte is part of. Thus, in practice a VD byte can take any value as it will depend upon the VD instruction as defined by the VD scheme.

The third symbol in the final word of FIG. 8A (byte 14) is a composite symbol, formed of five bits relating to lane margining (‘LMR’) and three vendor-defined bits (VD). Specifically, bits [2:0] can be vendor-defined and bits [7:3] relate to lane margining. The effect of this that is relevant to this discussion is that a maximum of three bits of byte 14 can be used for conveying a VD instruction. Nevertheless, byte 14 of FIG. 8A should be understood to be a ‘VD byte’ as discussed above because a portion of byte 14 (0.375 of a byte) can be used to store a VD instruction or part thereof. Other encoding schemes in which this entire byte is available for conveying a VD instruction are also possible.

The entire control skip ordered-set shown in FIG. 8A can thus have either of the following exemplary forms (all values in hexadecimal):

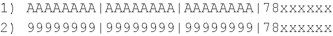

In each case, the ‘I’ character represents a word boundary and ‘x’ represents any value, determined in practice by the PRTY symbol in the case of byte 13, the VD instruction, VD scheme and LMR symbol in the case of byte 14, and the VD instruction and VD scheme in the case of byte 15. The values given above are not limiting and in general any structure having a format similar to, or the same as, that above can be used. The headers are not shown in this representation.

It should also be appreciated that the number of words containing just the skip symbols ‘SKP’ can vary, with a corresponding increase or decrease in the block size. This is because a word of skip symbols can be added to or removed from block 805 as part of a rate adaptation process. The rate adaptation process involves synchronising a set of First In First Out (FIFO) buffers across multiple lanes of a PCIe link. Skip symbols are removed or added to a given lane's data stream 800 in order to synchronise reading out of the FIFO buffers across the link. In one embodiment, a control skip ordered-set can have as few as four skip symbols (i.e. one word of skip symbols) and the control word containing the control skip symbol C-SKP, or as many as twenty skip symbols (i.e. five words of skip symbols) before the control word containing the control skip symbol C-SKP. This results in a variable block size from 68 bits to 204 bits (including the sync header bits and the zeroed headers). These values are purely exemplary and other minimum and maximum block sizes can be used instead. The number of skip symbols does not affect the VD bytes because these are indicated using the control skip symbol C-SKP that is always present in the final word of block 805 no matter the size of the block. This final word can be referred to as the ‘control word’.

In the case of FIG. 8A, 1.375 VD bytes are present per block. This gives a maximum information carrying capacity of 1.375 bytes per block for a VD scheme. VD schemes that require more than 1.375 bytes to convey a VD instruction are also possible, as in this case a single VD instruction can be spread out over multiple control skip ordered-sets that are each like block 805. For example, a 4-byte VD instruction could be sent using three control skip ordered-sets in three distinct blocks. The three blocks could be sent via the same lane as each other, but at different times, or the blocks could be sent at the same time as each other via respective lanes. It is also possible to transmit a data package, such as retimer firmware, using the VD bytes, where many control skip-ordered sets are used to send the updated firmware to the retimer.

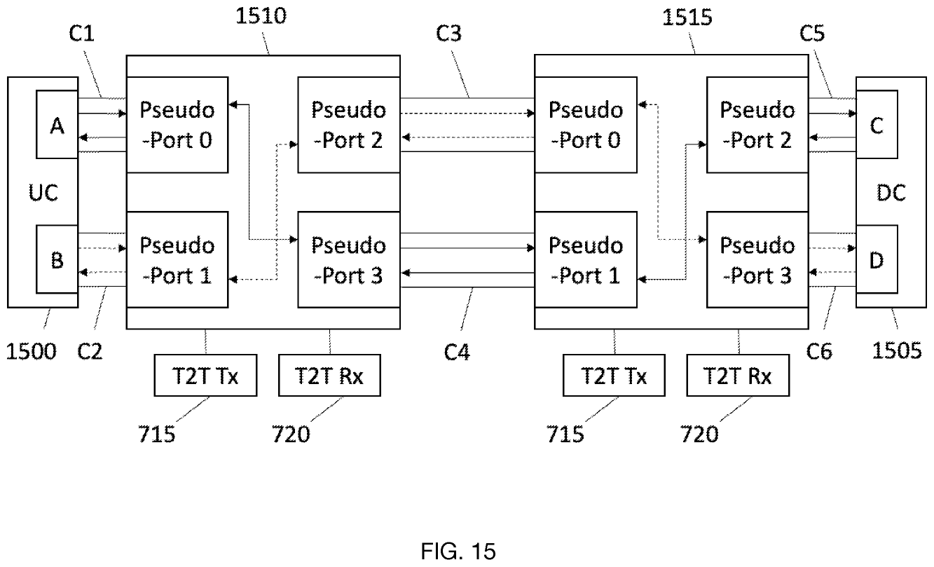

VD schemes using VD instructions as described above can have a number of uses. As one non-limiting example, VD instructions could be used for skew correction with the VD instructions being defined according to a skew correction VD scheme. This is described in more detail in connection with FIG. 15 later.

As another non-limiting example, VD instructions can be used as an in-band configuration channel for the retimer. That is, a VD instruction can provide configuration information to the retimer, e.g. setting a retimer operating mode, specifying certain operating parameters, and the like. This can be particularly useful in situations where an out-of-band configuration channel is not available. One such example of this is in the case of a retimer that is located on a riser card. This is because the system management bus (SMBus), which is often used for out-of-band configuration of components, does not typically extend to the riser card. A retimer (or another component) located on a riser card therefore could be configured using in-band VD instructions given the non-availability of the SMBus.

FIG. 8B shows certain elements of a retimer as described herein in detail in order to demonstrate one way in which a VD instruction can be detected and acted upon. This explanation is provided in the context of leader die/tile 235 but it should be appreciated that a follower tile can equally implement this element of the disclosure. It should also be appreciated that some components are omitted in FIG. 8B in the interests of clarity of explanation of the salient points.

PCIe traffic enters on the left of the diagram via PHY 270 from an upstream component in the PCIe link, e.g. a root complex or switch. The PCIe traffic is decoded by PCS Rx 855 and the decoded packets are provided to First In First Out buffer (FIFO) 862. FIFO 862 performs rate adaptation in a manner that is known and as such is not detailed here.

Coupled to FIFO 862 is symbol detector 860 that scans the data received by FIFO 862. The data as received by FIFO 862 is referred to herein as a ‘PCIe data stream’. This is a PCS-decoded data stream in the case of 8b10b or 128b130b encoding (PCIe gens 1 to 5), or the data stream as output by PHY 270 in the case of 1b1b encoding (PCIe gen 6).

Symbol detector 860 detects control information that is embedded in the data stream. The control information is contained in a control skip ordered-set of the type discussed above.

Upon detection of a control skip ordered-set, symbol detector 860 identifies one or more VD bytes contained in the control skip ordered-set. Symbol detector 860 can detect the control skip ordered-set by the presence of the control skip symbol C-SKP. Some or all of the remaining bytes in the word containing the control skip symbol are then known by symbol detector 860 to be VD byte(s).

The symbol detector 860 is coupled to a status register 865 and has the capability to write to status register 865. Upon detecting a control skip symbol, symbol detector 860 can write status data to status register 865. The status data that is written is based on the VD byte(s) contained in the word that also contains the control skip symbol that symbol detector 860 detected. For example, symbol detector 860 could copy the VD byte(s) to status register 865. Processing of the VD byte(s) by symbol detector 860 before storing a processing result in the symbol detector 860 is also possible.

Symbol detector 860 can inform CPU core 200 that control information has been detected by raising an interrupt request (IRQ) via IRQ controller 220, e.g. responsive to the status data being written to the status register 865. CPU core 200 can then read status register 865 and obtain the status data. CPU core 200 then takes an action based on the status data. The action can be any retimer control action, e.g. changing an operating mode of the retimer, for example adjusting a configuration of MUX 700, or setting updated skew parameters. Another action that can be taken is to instruct the retimer to provide diagnostic information. This may be alternatively known as ‘telemetry’. The diagnostic information can comprise any information relating to the current state of the retimer, including but not limited to: one or more values currently held in one or more registers of the retimer; eye-related information such as eye height and/or eye width; a bit-error rate (BER) of the retimer; one or more values of one or more counters of the retimer; and the like. The diagnostic information can assist in recovering a component of the retimer that has entered an error state, among other things. It will be appreciated that some diagnostic information is lane-specific and in such cases the diagnostic information can be provided on a ‘per-lane’ basis. Selection of a lane or lanes can be performed by targeting the respective symbol decoders corresponding to the lane or lanes of interest. The above is not an exhaustive list and other actions are also possible and within the scope of this disclosure.

It is possible for the VD byte(s) to identify a channel for the retimer to use when providing diagnostic information or performing any other function relating to the VD instruction. The channel can be in-band; that is, the retimer responds by generating a VD response that is encoded in the same manner as a VD instruction and sent to the device that generated the VD instruction, e.g. CPU core 200. Alternatively, the channel can be out of band; that is, the retimer responds using some other channel such as an I²C bus, SPI bus, etc.

Symbol detector 860 can be configured to take further action in addition to raising an IRQ, or in the alternative to raising an IRQ. For example, symbol detector 860 can pause traffic flow, e.g. by altering the setting of a multiplexer of the retimer, and transmit electrical idle ordered-sets (EIOS) whilst it waits for CPU core 200 to handle the IRQ that symbol detector 860 raised. This action can be taken in the case where symbol detector 860 does not recognise the VD instruction that it has received, for example. Alternatively, if symbol detector 860 does recognise the VD instruction that it has received, symbol detector 860 can take action without waiting for the relatively slow process of waiting for CPU core 200 to handle an interrupt request.

CPU core 200 and/or symbol detector 860 have access to a definition library 875 that stores VD instruction definitions. A VD instruction definition identifies the VD instruction (i.e. the VD byte(s) that comprise a given VD instruction) and also identifies the action(s) that should be taken when that VD instruction is detected. The definition library thus provides CPU core 200 and/or symbol detector 860 with a mechanism for identifying a particular VD instruction and taking action based on it.

The action(s) to be taken can be identified by a VD instruction definition by associating a respective pointer with a given VD instruction, the pointer pointing to a memory location (e.g. in data RAM 215 or a memory or register coupled to symbol detector 860) that contains code for execution upon detection of the corresponding VD instruction. This code, and/or a corresponding VD instruction definition, can be provided to the retimer as part of a vendor-defined instruction package that is included in a firmware update, e.g. in a firmware update data package. Generally speaking, the vendor-defined instruction package includes all information that is necessary to identify a VD instruction and to act upon this instruction.

Definition library 875 can be stored in one or more registers and/or a memory that is accessible to CPU core 200, e.g. data RAM 215, and/or accessible to symbol detector 860, e.g. a register or memory coupled to symbol detector 860. Symbol detector 860 and CPU core 200 could have access to the same definition library, or they can each have access to a respective definition library. The definition library 875 can also be part of a firmware image stored in SPI flash 240, with the boot sequence including loading the definition library 875 from the firmware and writing the definition library 875 to one or more registers and/or a memory, e.g. data RAM 215 and/or a register or memory coupled to symbol detector 860. In the case where updated firmware is transmitted to the retimer, the updated firmware can include an updated definition library that includes one or more new VD instruction definitions and/or one or more modified VD instruction definitions relative to the VD instruction definitions already accessible to CPU core 200 and/or symbol detector 860. New and/or updated instruction sets (code) respectively corresponding to the new and/or modified VD instruction definitions can also be included with the updated firmware.

FIFO 862 provides an output data stream that comprises data stream 800, possibly with modification to remove control skip symbols and/or other control symbols (e.g. skip symbols). This is however not essential as FIFO 862 can provide as output data stream 800 in an unmodified form. The output of FIFO 862 is provided to PCS transmitter (Tx) 870 (FIG. 8B). PCS Tx 870 performs the inverse of PCS Rx 855 as PCS Tx 870 encodes traffic it receives and transmits the encoded traffic to PHY 270 for onward routing.

PCS Rx 755 and symbol detector 860 can be considered to be part of a larger entity that provides PCIe PCS decode/encode functionality. The configuration shown in FIG. 8A is thus not limiting as the functionality of symbol detector 860 could be incorporated within PCS Rx 855, for example. Further alternative configurations that offer equivalent functionality are also possible. Each lane of a PCIe link has respective PHYs, a respective PCS Rx, PCS Tx, symbol detector and status register. This means that VD instructions are lane specific. In the case where a VD instruction relates to a link-level action, e.g. switching a retimer mode, the VD instruction to trigger this switch can be sent using just one lane of a multi-lane link. In the case where a VD instruction relates to a lane-level action, e.g. providing lane skew information, a respective VD instruction is included in the data stream for each lane.

In the case of 1b1b encoding (PCIe gen 6), PCS Rx 755 and PCS Tx 870 can be omitted. This is because PCIe gen 6 does not make use of PCS encoding/decoding such that symbol detector 860 can detect symbols in the PCIe data stream in the format output by PHY 270.

Referring to FIG. 2, communication between symbol detector 860, status register 865, IRQ controller 220 and CPU core 200 can take place via APB interconnect 225 in the case of leader tile 235.

Follower tiles 400, 600 and 600′ can each also implement the circuit shown in FIG. 8B with the difference that in these cases IRQ controller 220 and CPU core 200 are located on a different tile (specifically, leader tile 235). In this case, communication between symbol detector 860 or status register 865 and IRQ controller 220 or CPU core 200 additionally makes use of the T2T SPI bus discussed above. Specifically, symbol detector 860 or status register 865 transmit and receive data over the local APB interconnect that is on the same tile as symbol detector 860 or status register 865. This data traverses between the tiles via the T2T SPI bus and is routed over the leader tile via leader tile APB interconnect 225. A global address space can be defined that encompasses all tiles in a multi-tile retimer, enabling each status register on each tile to have a unique APB address or address range in this global address space. This is not essential and other addressing schemes can be used instead.

It will be apparent from the discussion above that the definition library 875 controls the set of VD instructions that a given retimer can detect and act upon. Implementing new functionality can therefore be dependent on the content of the definition library 875.

Modifying the definition library 875 can be achieved via a firmware update. Given the ability of the VD instructions to control aspects of the retimer operation, it is important that the definition library 875 only holds definitions that are approved by an appropriate entity, e.g. a manufacturer. Unauthorised definitions in the definition library 875 could lead to unstable or unexpected operation of the retimer and/or represent a security threat (e.g. enable covert traffic snooping or traffic mirroring). This is particularly true of ‘in-field’ type firmware updates that require the definition library 875 to be updated in a retimer that has already been deployed and is in use, i.e. in the situation where the retimer is out of the direct control of the manufacturer.

It is possible for embodiments to provide in-band data transmission capabilities, e.g. to provide an in-band firmware update. ‘In-band’ here refers to the channel that the retimer is retiming when in mission mode-so in the case of a PCIe retimer, the data package is sent via a PCIe link that the retimer is retiming in mission mode. This has utility at least in scenarios where alternative sideband channels are either not available, e.g. in the case of a retimer located on a riser card, or where alternative sideband channels are relatively low bandwidth, e.g. an I²C channel. Additionally, some embodiments are able to transmit updated firmware in mission mode meaning that operation of the retimer is not disrupted by the firmware update being transmitted.

This disclosure contemplates a number of different encoding schemes for transmitting a data package such as a firmware update to a retimer using an in-band channel. These encoding schemes are described immediately below. While these schemes are described in the context of a retimer, it should be appreciated that any PCIe-compliant device, e.g. a redriver, or general purpose input/output device, can make use of the encoding schemes described below.

The following disclosure makes reference at times to an ‘in-band retimer message’. This is understood to be a type of VD instruction as discussed above that relates specifically to the transmission of a data package to the retimer. Thus, an in-band retimer message has a corresponding VD instruction definition that can be used by the retimer to identify the in-band retimer message in a PCIe data stream or PCS-decoded PCIe data stream. The in-band retimer message also has corresponding code that can be executed to carry out the task(s) associated with the in-band retimer message, e.g. setting up the retimer to receive the data package, and handling the reception and storage of the data package.

### Control Skip Ordered Sets as a Transport Channel

In this embodiment, control skip ordered-sets (‘C-SKP’) are used both as the channel for signalling to retimer 235 that a data package is incoming and the channel for transmitting the data package. At times in the following the data package is said to be a firmware update for retimer 235, but it will be appreciated that the scope of this disclosure is not limited to firmware updates as any data can be sent in this manner. The data can be sent by an entity external to retimer 235 such as a root complex (not shown in the figures) that is communicating with retimer 235 via a PCIe link.

In this embodiment, referring to FIG. 8A, only the ‘VD’ block of a C-SKP is used to carry in-band messages and data, meaning that each C-SKP is treated as having one byte's worth of space available for use by the in-band messaging protocol. This is for ease of description and implementation, but it should be appreciated that variant in-band messaging protocols that also make use of the three VD bits available in the block shared with the LMR bits are also possible.

FIG. 8C provides an illustration of a C-SKP based encoding scheme for transmission of data packages in-band via a PCIe link that supports C-SKPs, e.g. a PCIe Gen 4, Gen 5 or Gen 6 link. FIG. 8C should be read vertically, i.e. C-SKP_0 is the first C-SKP transmitted over a lane of the link. Each C-SKP can take the form shown in FIG. 8A, for example. The in-band retimer message can be a VD message as described above and can be decoded by symbol decoder 860 as described above. Briefly, symbol detector can be configured to detect the in-band retimer message by identifying a pattern of bits in the PCS-decoded data stream (PCIe gen 1 to 5) or the PCIe data stream (PCIe gen 6) corresponding to a vendor-defined instruction definition stored in a definition library accessible to the symbol detector, where the vendor-defined instruction definition is associated with the in-band retimer message. As described above, the definition library can be stored in one or more flip flops, registers, memories, etc. that are accessible to the symbol detector.

In this embodiment the in-band message is 1 byte in length, but this is not limiting on the scope of this disclosure as in-band messages of other lengths are possible. It will be appreciated that the values of the bits of the in-band message can be varied according to requirements, so long as retimer 235 can recognise the in-band message, e.g. using definition library 875 to match the in-band message bits to an entry within definition library 875 that corresponds to a ‘data package incoming’ instruction.

Other data is transmitted between adjacent C-SKPs and this is illustrated in FIG. 8C by dashed boxes labelled ‘data’. This is used as a convenient shorthand as in practice many bytes are transmitted between adjacent C-SKPs, including PCIe data and other control symbols that are sent in the L0 state, such as a SKP ordered set.

To initiate a transmission, a start C-SKP, C-SKP_0, is transmitted over a PCIe link to retimer 235. C-SKP_0 is referred to as a ‘start C-SKP’ as it indicates to retimer 235 that a data package is incoming. That is, detection of C-SKP_0 by retimer 235 causes retimer 235 to expect a data package to be sent such that retimer 235 is ready to capture the data package.

An address C-SKP, C-SKP_1, may follow the start C-SKP_0. In the illustrated embodiment the C-SKP_1 is the next C-SKP transmitted over the PCIe link, but this is not limiting as one or more C-SKPs or other control signals (e.g. a skip ordered-set, SKP) can be transmitted over the link between C-SKP_0 and C-SKP_1. The address C-SKP can be omitted in cases where it is not needed, such as a link that includes just one retimer like retimer 235 or a case where all data packages are to be received by all retimers of a given manufacture in a link simultaneously.

Address C-SKP_1 specifies an address of retimer 235. This allows retimer 235 to be sure that it is the intended recipient of the incoming data package. This can be useful in situations where multiple retimers of the same manufacture, e.g. two retimers, are in a single link, as use of the address C-SKP_1 enables one of the multiple retimers to be targeted for a particular data package. Any address format can be used so long as it is reliably identifiable by retimer 235.

In the illustrated embodiment the address fits within one byte, such that a single C-SKP symbol can carry the entire address. This is not a limitation of the scope of this disclosure, however, as addresses of more than one byte in size can be used and carried by a corresponding number of C-SKP symbols. For example, a 2-byte PCIe ‘Device Bus Function’ (D/B/F) address format can be used—in this case, two C-SKP symbols are used to carry the address, with a respective byte of the address being carried by each C-SKP symbol.

Retimer 235 can be assigned an address by writing the address to an address register (not shown) located on retimer 235. In some cases the address is static and is written during manufacture. This is suited to a scenario in which details of the system in which retimer 235 is to be deployed are known in advance. In other cases the address is dynamically assigned in a configuration or startup phase, e.g. during a PCIe enumeration process. The address can be assigned by a root complex or by CPU core 200. This is suited to a scenario in which details of the system in which retimer 235 is to be deployed are not known in advance. Retimer 235 can compare an address received in one or more address C-SKP symbols with the address stored in the address register. In the case of a match, retimer 235 continues processing the incoming symbols relating to the in-band data package. In the case of no match, retimer 235 ignores additional incoming symbols relating to the in-band data package other than if another start C-SKP is received. This is because another start C-SKP signals that a new data package is incoming, so retimer 235 is configured to check whether this new data package is addressed to it.

A size C-SKP, C-SKP_2, can also be included in the data stream. If present, the size C-SKP specifies the total size of the data package, including any error-correcting bits like a CRC or parity bit(s) that may be included with the data package. Multiple size C-SKPs can be used in the case where the total size of the data package requires more than one C-SKP to represent it. For example, a 128 KB package (131,072 bytes) requires 17 bits to represent this number of bytes and hence three size C-SKPs can be used. Alternatively, some form of encoding scheme can be used, e.g. representing the size of the data package in kilobytes rather than bytes, such that one size C-SKP can be used for a 128 KB package. In such cases the data package may be zero padded if necessary to ensure that it is precisely a representable number of kilobytes.

A payload start C-SKP, C-SKP_3, is transmitted immediately prior to the first C-SKP that contains payload (i.e. the data package itself). The payload start C-SKP signals to retimer 235 that the next C-SKP contains payload data. Here, ‘immediately prior’ means that there are no C-SKP symbols between the payload start C-SKP and the first C-SKP containing payload. This does not prevent other, unrelated data or control symbols from being transmitted between the payload start C-SKP and the first C-SKP containing payload data. For example, one or more skip-ordered sets (SKP) can be transmitted between the payload start C-SKP and the first C-SKP containing payload data.

If a size C-SKP has been transmitted, retimer 235 can calculate a number of payload C-SKPs that it expects to receive in order to fully receive the data package (including any error-correcting bits like a CRC or parity bits). For example, in the 1 byte per C-SKP embodiment discussed here, retimer 235 can expect to receive 131, 072 payload C-SKPs in the case of a 128 KB data package. If retimer 235 does not receive this many C-SKPs, retimer 235 can raise an error with the root complex or other entity responsible for sending the data package. The error can be raised via an in-band channel, i.e. retimer 235 transmits one or more error C-SKPs to the root complex or other entity. Alternatively, an out of band channel can be used, with there being no limitation on the nature of this out of band channel.

FIG. 8C shows a set of CRC bytes starting at C-SKP_N+1 and terminated by C-SKP_M, this being the final CRC byte. In an alternative embodiment the CRC bytes can be omitted or substituted with any other type of error checking mechanism, e.g. parity bits.

The data package transmission can be terminated with a stop C-SKP, C-SKP_M+1 in FIG. 8C. The stop C-SKP signals to retimer 235 that the data package has been transmitted in its entirety. The stop C-SKP can be used in addition to the size C-SKP, or without a size C-SKP. Alternatively, if a size C-SKP is used, the stop C-SKP can be omitted as retimer 235 can be configured to assume that the data package is complete once an amount of data equal to the value of the size C-SKP has been received.

It is possible to transmit a data package in multiple fragments using the encoding scheme of FIG. 8C. In this case, each fragment is transmitted as described above and shown in FIG. 8C. An additional ‘fragment ID’ C-SKP can be used to indicate that each transmission is a fragment of the whole data package and further to specify which fragment it is, e.g. fragment 1 of 3, fragment 2 of 3, etc. This information enables retimer 235 to assemble the fragments together in the correct order so as to reconstruct the complete data package. Fragments can be transmitted in sequence over a single lane, or in parallel over multiple lanes.

The PCIe protocol specifies a certain minimum distance between adjacent C-SKPs, with this distance being defined as a number of symbols. It should thus be appreciated that, in general, data is being transmitted in a normal PCIe fashion between C-SKPs. This is shown in FIG. 8C via the dashed boxes labelled ‘Data’, each of which represent one or more bytes of data and/or other control information (e.g. a SKP symbol).

It is expected that a data package transmission rate of approximately 100 to 200 KB/s can be achieved using the encoding technique of FIG. 8C, taking into account the minimum distance between adjacent C-SKPs required by the PCIe protocol. This data rate will vary with PCIe generation, with higher generations having a corresponding higher data rate that may exceed 200 KB/s. Given that a retimer firmware update package is typically of the order of kilobytes, e.g. 64 KB or 128 KB, it can be expected that a firmware update package can be transmitted in this manner in around one second and potentially less, particularly for higher generation PCIe links.

As C-SKP symbols are transmitted as part of a PCIe link in the L0 state, embodiments using C-SKP symbols to transport a data package in-band do not disrupt or modify the normal traffic flow of an established PCIe link operating in the L0 state. Additionally, as components downstream of retimer 235 will simply ignore the in-band messages and data contained with the C-SKP symbols, retimer 235 does not need to adjust its retiming operations and can retimer and forward the C-SKP symbols in the same manner as with any other traffic retimer 235 receives in the L0 state.

In addition to, or in the alternative to, check information such as a CRC, the data package can include a hash code that allows the integrity of the data package to be verified by retimer 235. This is useful both for security purposes to check for deliberate modification and error checking. Any suitable hash generation algorithm, e.g. SHA-224, can be used.

Following receipt of the data package, retimer 235 can be configured to transmit an acknowledgement C-SKP back to the sender of the data package, e.g. a root complex. The acknowledgement C-SKP can indicate whether the data package received by retimer 235 has been successfully received, based on e.g. CRC checks, parity bit checks and/or a comparison between the transmitted hash of the data package and a locally generated version of the hash generated by retimer 235. The acknowledgement C-SKP can indicate ‘success’ or ‘failure’, where in the ‘failure’ case the root complex can be configured to re-transmit the data package to retimer 235. More information in the failure case can be provided, e.g., an indication of one or more bytes that were not received correctly by retimer 235 based on some form of error checking like CRC or a parity bit. Additional acknowledgement C-SKPs can be sent if the failure information cannot fit within the initial acknowledgement C-SKP.

While it is shown in FIG. 8C that all C-SKP symbols are transmitted on a single lane, this is not limiting on the scope of this disclosure as multiple lanes can be used to transmit C-SKP symbols containing the data package. This can further increase the data transfer rate and reduce the time for the data package to be received by retimer 235. The data package fragmentation technique discussed above could be employed to achieve multi-lane transmission, with a different fragment being transmitted on each lane of the multiple lanes. The scope of this disclosure is not limited to this however, and any technique capable of enabling retimer 235 to receive the data package via multiple lanes is within scope.

### Training Ordered Sets as a Transport Channel

FIG. 8D illustrates another embodiment capable of in-band transmission of a data package to a retimer. In this embodiment, training ordered-sets (TOS) are used both as the channel for signalling to retimer 235 that a data package is incoming and the channel for transmitting the data package. Training ordered sets are exchanged in the Polling, Configuration and Recovery states of a link, meaning that in this embodiment the link between root complex or other issuing entity and retimer 235 is in one of these states when the data package transmission occurs. This embodiment can find utility in a situation where a link is established that does not support C-SKP symbols, e.g. a PCIe gen 1, 2 or 3 link.

The embodiment discussed here specifically makes use of modified TS1 and TS2 as defined in [PCIe Specification], or so-called ‘malformed’ TS1 and TS2. Here, the term ‘malformed’ indicates that the TS1 and TS2 have deliberately been modified in a way that deviates from the definition of training ordered sets provided in [PCIe Specification]. The effect of this is that other components in a PCIe link will dismiss the malformed TS1 and TS2 as erroneous, but retimer 235 can be configured to recognise these symbols as relating to data package transmission. In the following description, the term ‘TS1’ is used to refer to either modified TS1 or malformed TS1 symbols, and the term ‘TS2’ is used to refer to either modified TS2 or malformed TS2 symbols. The scope of this disclosure is not limited to these training ordered sets, however. PCIe gen 6 defines training ordered sets TS0 and TS1, and these training ordered sets (or malformed versions) can be used in the manner described for TS1 and TS2 below.

As can be seen from FIG. 8D, this embodiment shares some similarities with the embodiment using C-SKPs shown in FIG. 8C. The main difference is that each training ordered set is configured to carry two bytes of control information or payload data, compared with the one byte of FIG. 8C.

The first TS1/TS2, TS1/TS2_0, is a start and address TOS. Functionally, this is equivalent to the combination of start C-SKP_0 and address C-SKP_1 of FIG. 8C. Reference is thus made here to the discussion of those C-SKPs above.

The second TS1/TS2, TS1/TS2_1, is a size and payload start TOS. Functionally, this is equivalent to the combination of size C-SKP_2 and payload start C-SKP_3 of FIG. 8C. Reference is thus made here to the discussion of those C-SKPs above.

The third TS1/TS2, TS1/TS2_2, is the first TOS carrying payload data. In this embodiment two bytes of payload data are carried by every payload TOS. This disclosure is not limited to this, however, as each TOS could carry one byte of payload data twice to provide redundancy. A malformed TS1/TS2 could also provide additional payload carrying capacity as certain bytes of the TS1/TS2 could be deliberately set incorrectly to allow more than 2 bytes of data to be transported per TS1/TS2.

As shown in FIG. 8D, the final part of the payload is transported by TS1/TS2_N. Following this is a start CRC TS1/TS2, TS1/TS2_N+1. Reference is made to the start CRC C-SKP here, as TS1/TS2 N+1 this is functionally equivalent to C-SKP N+1.

The final part of the CRC is transported by TS1/TS2_M. Following this, a stop TS1/TS2, TS1/TS2_M+1, is transmitted. This is functionally equivalent to stop C-SKP_M+1 described above and signals to retimer 235 that the data package has been transmitted in its entirety.

Symbol detector 860 (FIG. 8B) can be configured to detect the TS0 and/or TS1 and/or TS2 symbols from the PCIe data stream, specifically PCS-decoded data stream output by PCS receiver 855 in the case of PCIe gen 1 to 5. In the case of PCIe gen 6, PCS receiver 855 and PCS transmitter 870 can be omitted and symbol detector 860 can be configured to detect TS0 and/or TS1 ordered sets directly from the PCIe data stream as output by PHY 270.

It can be the case that the number of TS1/TS2 ordered sets transmitted in a given link training session is limited to a maximum for the reason that it is expected that link training should be completed within that number of TS1/TS2 ordered sets. However, the maximum number of TS1/TS2 ordered sets may be insufficient to transport the complete data package.

To address this issue, the data package can be split into chunks that are each of a size that is less than or equal to the data carrying capacity of the maximum number of TS1/TS2 ordered sets. Link training can be initiated multiple times, with each link training session being used to transport one of the data chunks using TS1/TS2 ordered sets. Assuming a data package of N bytes and a link training session data transport capacity of M bytes, M<N, the data package can be split into N/M byte chunks. M link training sessions can then be initiated in succession over a single lane, or in parallel over multiple lanes, or a combination thereof, to enable all N bytes of the data package to be transported. Since N is not guaranteed to be a multiple of M, the final chunk may be a different size than the preceding chunk(s), or the final chunk can be zero padded to be the same size as the preceding chunk(s). This is just one way of splitting up a data package and is not limiting on the scope of this disclosure as other splitting techniques can be employed instead.

Alternatively, retimer 235 can be configured to deliberately corrupt TS1/TS2 ordered sets that it receives from a root complex during a data package transmission before forwarding them on to the endpoint that retimer 235 is connected to. Retimer 235 may also deliberately corrupt TS1/TS2 ordered sets that it receives during the data package transmission from the endpoint before forwarding them on to the root complex. Corruption occurs after retimer 235 has retrieved data package bytes from the TS1/TS2 ordered sets. Corrupting the TS1/TS2 ordered sets can involve modification of any byte(s) of the TS1/TS2 ordered sets that causes them to be interpreted as invalid by the root complex and endpoint. Corrupting the TS1/TS2 ordered sets causes the root complex to consider that a valid training sequence has not been transmitted, such that the root complex repeats TS1/TS2 transmission. In this way, it is possible to cause more than the maximum number of TS1/TS2 ordered sets to be transmitted in a single training session.

A combination of the aforementioned techniques can be employed, i.e., corruption of the TS1/TS2 ordered sets can be used to transport a chunk of a data package that is larger than the maximum number of TS1/TS2 ordered sets transmitted in a single training session. This can be useful in a situation where some other limitation exists, e.g. where the root complex or endpoint is configured to abort attempting to establish a valid training link after some number of corrupt TS1/TS2 ordered sets is received, or some preset time has elapsed.

It is also possible to substitute corrupting the TS1/TS2 ordered sets before forwarding them on with not forwarding the TS1/TS2 ordered sets, such that the endpoint does not receive any TS1/TS2 ordered sets from the root complex and vice versa. This can have the same effect as corrupting the TS1/TS2 ordered sets as both the root complex and endpoint believe that a valid training session has not been started and hence continue attempting to establish a valid training session, thus extending the number of TS1/TS2 ordered sets beyond the maximum.

As in the C-SKP case, the data package can include a hash code that allows the integrity of the data package to be verified by retimer 235.

Following receipt of the data package, retimer 235 can be configured to transmit an acknowledgement TS1/TS2 back to the sender of the data package, e.g. the root complex. The acknowledgement TS1/TS2 can have the same properties as the acknowledgement C-SKP discussed earlier. Multiple TS1/TS2 ordered sets can be used if needed.

While it is shown in FIG. 8D that all TS1/TS2 ordered sets are transmitted on a single lane, this is not limiting on the scope of this disclosure as multiple lanes can be used to transmit TS1/TS2 ordered sets containing the data package. This can further increase the data transfer rate and reduce the time for the data package to be received by retimer 235. The data package fragmentation technique discussed above could be employed to achieve multi-lane transmission, with a different fragment being transmitted on each lane of the multiple lanes. The scope of this disclosure is not limited to this however, and any technique capable of enabling retimer 235 to receive the data package via multiple lanes is within scope.

### Transaction Layer Packets as a Transport Channel

FIG. 8E illustrates a further embodiment capable of in-band transmission of a data package to a retimer. This embodiment makes use of C-SKPs to signal to retimer 235 that a data package is incoming, but the data package itself is transmitted using one or more transaction layer packets (TLPs).

As shown in FIG. 8E, the data package transmission is initiated using a C-SKP sequence that is similar to that of FIG. 8C. Briefly:
C-SKP_0 is a start C-SKP that indicates to retimer 235 that a data package is incoming.
C-SKP_1 and C-SKP 2 are address C-SKPs that in this embodiment is 2 bytes as it conforms to the Bus. Device. Function address format of a PCIe enumeration process. These address C-SKPs can be omitted since it is possible for retimer 235 to determine whether the data package is addressed to it based on address information provided in a TLP header (see later for further information on this).
C-SKP_3 is a size C-SKP that specifies the total size of the data package, including any error checking data like a CRC or parity bit. This can be omitted if a stop C-SKP is used, since in that case retimer 235 can determine the end of the data package based on the stop C-SKP.
C-SKP_4 is a payload start C-SKP that signals to retimer 235 that the next TLP contains payload data.

The C-SKPs of this embodiment can be detected by the components shown in FIG. 8B in the same manner discussed above in connection with FIG. 8C.

In FIG. 8E, adjacent C-SKPs are separated by data shown in dashed boxes. Reference is made to the corresponding discussion above in connection with FIG. 8C.

Following C-SKP_4 is one or more TLPs that contain package data. In embodiments that do not switch retimer 235 to endpoint mode, the length of each set of one or more TLPs is selected so that it is less than or equal to the depth of the storage that is to receive the TLPs, e.g. the depth of the buffer of a logic analyzer or the size of some other buffer (see below). This prevents buffer overflow.

As the embodiment of FIG. 8E transports the package data in TLPs, it is necessary to provide retimer 235 with data package extraction logic that the ability to decode TLPs. The necessary TLP decoding is provided by a transaction layer packet decoder that in this embodiment comprises a logic analyzer (not shown). The logic analyzer is configured to capture one or more TLPs from the PCIe data stream, i.e. the PCS-decoded data stream that is output by PCS receiver 855 in the case of PCIe gen 1 to 5 or the output of PHY 270 in the case of PCIe gen 6, and to store these TLPs in a buffer. The buffer has a depth which is a measure of the maximum number of TLPs that the buffer can store at any given time. The logic analyzer can perform any necessary decoding to extract the TLP payload data and write this extracted payload to a memory for further processing, e.g. by CPU core 200.

The logic analyzer can be configured to monitor one lane of a PCIe link, such that all the TLPs that transport the package data are sent on this lane. Alternatively, the logic analyzer, or a plurality of logic analyzers, can be used to monitor a plurality of lanes, e.g. all the lanes of a link, with TLPs that transport the package data being sent on all lanes that are being monitored.

Alternatively, the transaction layer packet decoder can comprise a link controller that is used in place of a logic analyzer to perform TLP decoding. In the link controller case, retimer 235 acts as a PCIe endpoint while receiving the data package and reverts to a retimer once the package is fully received, whereas with the logic analyzer or equivalent, retimer 235 can keep the existing link configuration.

As a further alternative, the transaction layer packet decoder can comprise a buffer that stores TLPs and a processor such as CPU core 200 to perform the TLP decoding. The scope of this disclosure is not limited in this regard and any other component or components capable of decoding TLPs can be used for the transaction layer packet decoder.

The TLPs that transport the data package can be TLPs having a TLP header and TLP payload packets, in accordance with a PCIe specification. Further details regarding the TLP structure are thus not provided here, other than the following.

In any embodiment that does not switch to an endpoint mode for retimer 235, e.g. the embodiment that makes use of a logic analyzer, the address of each TLP that contains part of the data package as payload is set to an invalid address, e.g. an address that is outside the range of addresses assigned during enumeration of the system in which retimer 235 is deployed. The reason for this is that the logic analyzer or equivalent does not remove the TLPs from the PCIe data stream, meaning that the TLPs will be retimed by retimer 235 and transmitted onward to an endpoint. The endpoint will simply drop these TLPs as they have an invalid address, meaning that transmission of other data is not affected or interrupted by the data package transmission.

The TLP address in each TLP header relating to the data package matches the address specified in the address C-SKPs, i.e. C-SKP_1 and C-SKP_2 of FIG. 8E, if address C-SKPs are sent. This address can be assigned to retimer 235 after enumeration has been completed such that it can be guaranteed that the address is invalid from the perspective of the wider system that retimer 235 is part of. Retimer 235 can store the address in one or more registers that are accessible to the logic analyzer or equivalent to enable it to identify TLPs that are addressed to retimer 235 in the PCIe decoded data stream.

After the data package has been transmitted, a stop C-SKP, C-SKP_5 can be transmitted that signals to retimer 235 that the data package has been transmitted in its entirety.

It is possible to transmit a data package in multiple fragments using the encoding scheme of FIG. 8E. In this case, each fragment is transmitted as described above and shown in FIG. 8E. An additional ‘fragment ID’ C-SKP can be used to indicate that each transmission is a fragment of the whole data package and further to specify which fragment it is, e.g. fragment 1 of 3, fragment 2 of 3, etc. This information enables retimer 235 to assemble the fragments together in the correct order so as to reconstruct the complete data package. Each fragment could be transmitted in parallel over a respective lane in a multi-lane link to increase the bandwidth available for transmission of the data package.

As C-SKP symbols and TLPs are transmitted as part of a PCIe link in the L0 state, embodiments using C-SKP symbols and TLPs to transport a data package in-band do not disrupt or modify the normal traffic flow of an established PCIe link operating in the L0 state. Additionally, as components downstream of retimer 235 will simply ignore the in-band messages and data contained with the C-SKP symbols and the incorrectly addressed TLPs, retimer 235 does not need to adjust its retiming operations and can retimer and forward the C-SKP symbols in the same manner as with any other traffic retimer 235 receives in the L0 state.

In addition to, or in the alternative to, check information such as a CRC, the data package can include a hash code that allows the integrity of the data package to be verified by retimer 235. This is useful both for security purposes to check for deliberate modification and error checking. Any suitable hash generation algorithm, e.g. SHA-224, can be used.

Following receipt of the data package, retimer 235 can be configured to transmit an acknowledgement C-SKP back to the sender of the data package as discussed above in connection with the embodiment of FIG. 8C.

The embodiment of FIG. 8E typically has a greater data package transmission rate compared to FIG. 8C because TLPs can be transmitted at the data rate of the lane or link being used to carry the TLPs. Delays are introduced in embodiments that do not switch retimer 235 to endpoint mode as in those embodiments it is necessary to halt TLP transmission whilst the TLPs received by retimer 235 are processed by a logic analyzer, CPU core 200 or some other TLP decode logic. However, these delays are expected to be relatively minor such that the overall time taken to transmit a data package is expected to be less than that of the embodiment of FIG. 8C.

The in-band data package transmission embodiments described above have applicability in a retimer that comprises a single tile as well as a multi-tile retimer. In the case of a multi-tile retimer, as described above it is typically the case that only the CPU core on a leader tile is active. It can therefore be desirable in such circumstances to deliver the data package directly to the leader tile for processing by the CPU core, e.g. writing the data package to a memory like SPI flash 240 in the case of a firmware update, to avoid the additional complexity and delays involved with transporting the data package from a follower tile to the leader tile in order for the CPU core to process the data package.

Embodiments are thus described that are selective about the lane(s) used to transmit a data package to a retimer or other device. Specifically, embodiments can transmit bits of a data package over one or more lanes that are coupled to a leader tile of the multi-tile retimer. In the case of multiple links each connected to a different tile of a multi-tile retimer, only lane(s) of the link(s) that are connected to the leader tile of the multi-tile retimer would be used for transmission of a data package. In the case of a multi-tile link, i.e., a link having some lanes coupled to the leader tile and some lanes coupled to a follower tile, only those lane(s) of the link that are coupled to the leader tile would be used for data package transmission. The leader tile can be the only tile of a multi-tile package with an active CPU core, for example.

The multi-tile retimer can be configured to, responsive to detection of an in-band retimer message signalling the start of a data package transmission (e.g., a start C-SKP or TS1/TS2 as described above) that is transmitted over a link, respond to a root complex with one or more lane status in-band retimer messages that specify one or more lanes of the link that are coupled to a leader tile of the multi-tile retimer. The root complex can then transmit the data package over the one or more lanes of the link identified in the one or more lane status in-band retimer messages. In this way, data package transmission over the one or more lanes coupled to the leader tile are used to carry the data package.

In the case where the data package is a firmware update package, as discussed above the firmware update can include one or more vendor-defined instruction definitions and associated code for execution by CPU core 200 when the corresponding vendor-defined instruction is detected. The code could be, for example, code to enable the retimer to reconfigure a multiplexor (e.g. MUX 700), reroute lanes, enter a loopback mode, switch to a low latency mode, provide latency information about lanes in a link, and/or other functionality.

FIG. 8F sets out a process for performing an in-band data package transmission to a retimer or other device in a PCIe link, according to an embodiment. While FIG. 8F makes reference to a retimer, this can be substituted with any other device capable of communicating using the PCIe protocol.

In element 890, one or more PHYs of a PCIe retimer receive a PCIe data stream. The retimer can be retimer 110 or retimer 235. The PCIe data stream can be a data stream that the retimer is retiming. The retimer can be a multi-tile retimer. The PHYs can be PHYs 270.

In element 891, a symbol detector of the PCIe retimer detects an in-band retimer message embedded in one or more control symbols within the PCIe data stream. Reference is made to the discussion above relating to the detection of in-band retimer messages.

In element 892, data package extraction logic of the PCI retimer monitors the PCIe data stream to detect a plurality of data package bit. The data package extraction logic performs this monitoring responsive to the detection of the in-band retimer message (element 891).

In element 893, the data package extraction logic writes the plurality of data package bits to a memory of the retimer. The plurality of data package bits can be part of a firmware update package.

### Secure Updating of Firmware of a Retimer

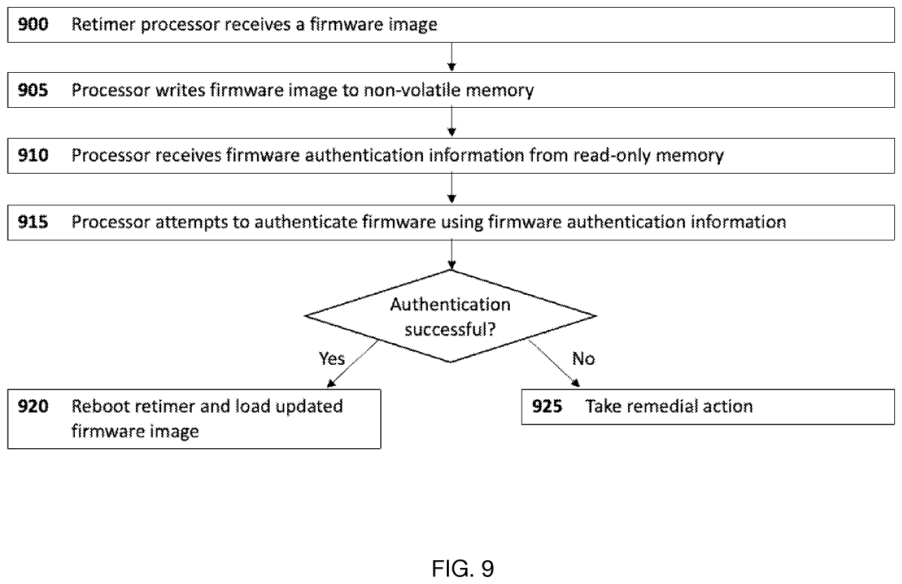

A first process for securely updating the firmware of a retimer to provide a modified definition library is shown in FIG. 9. In step 900, a processor of a PCIe retimer receives a firmware image including at least one vendor-defined instruction package. The retimer could be retimer 110 and the processor could be CPU core 200. The firmware image can be of the type shown in FIG. 3, specifically the components labelled ‘active’ in FIG. 3. The firmware image can be received from a source that is external to the retimer, e.g. a host processor that itself may have received the firmware image over a computer network like the internet or a cellular network. The firmware image could be sent by the host CPU to the external memory over a bus such as a system management bus. Alternatively, the firmware image can be sent to the processor directly using any of the in-band data package transmission embodiments described above. The vendor-defined instruction package includes at least one VD instruction definition of the type discussed above.

In step 905 the processor writes the firmware image to a non-volatile memory. The non-volatile memory can be SPI flash 240, for example. The firmware image can be transmitted over a bus such as a SMBus to the non-volatile memory, e.g. by a host CPU that received the firmware image from an external source.

The non-volatile memory can be partitioned as shown in FIG. 3 into an active and inactive region. In this case the firmware image is written to the inactive partition, i.e. to a set of memory addresses of the non-volatile memory that are marked as inactive. This means that a viable, working firmware image is present in the active region to enable the retimer to boot in the case where the updated firmware image that is being written to the inactive region is not used.

In step 910 the processor receives firmware authentication information from a read-only memory of the retimer. The read-only memory could be OTP memory 230. Receiving the firmware authentication information could thus involve reading the firmware authentication from the read-only memory, e.g. from OTP memory 230.

The firmware authentication information can comprise a hash of a public key. The hash of the public key is a fixed-length output of a hash function applied to the public key. One hash function that could be used is the SHA-224 hash algorithm which produces an output of 224 bits. The SHA-224 algorithm provides a public key hash that is of good security without being overly large in terms of bit size and hence taking up a significant amount of space of the read-only memory. This disclosure is however not limited to use of the SHA-224 algorithm as alternative hash algorithms can be used without departing from the scope of this disclosure.

It is possible to build redundancy into the read-only memory by storing two distinct copies of the firmware authentication information in the read-only memory. Each copy is stored at a different set of memory addresses within the read-only memory. In this configuration, retrieving the firmware authentication information can be performed as follows. Here it is assumed that a given bit of the firmware authentication information is being read, i.e. bit m of N-bit firmware authentication information, m being an integer running from 1 to N.

For each bit m, the bit is read from two distinct memory locations in the read-only memory that each store bit m. This produces a pair of read bits, one corresponding to each of the memory locations. A final read value is then generated by performing a logical OR operation on the pair of read bits. Once this process has been completed for all N bits, the set of final read values is taken as the ‘true’ or ‘correct’ set of values, i.e. the correct firmware authentication information. The rationale here is that it is extremely unlikely that an attempt to set a given bit in the read-only memory to ‘l’ would fail for both of the distinct memory locations, meaning that if at least one copy of the given bit is ‘1’, it can be stated with high confidence that the intention was for that bit to be set to ‘1’. The logical OR operation used as described above has the effect of stating that if at least one of the pair of bits is ‘1’, the final read value should be ‘1’.

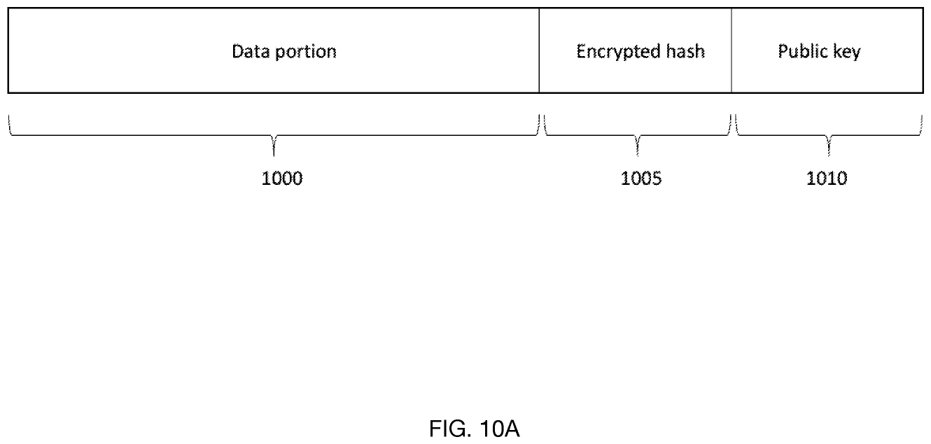

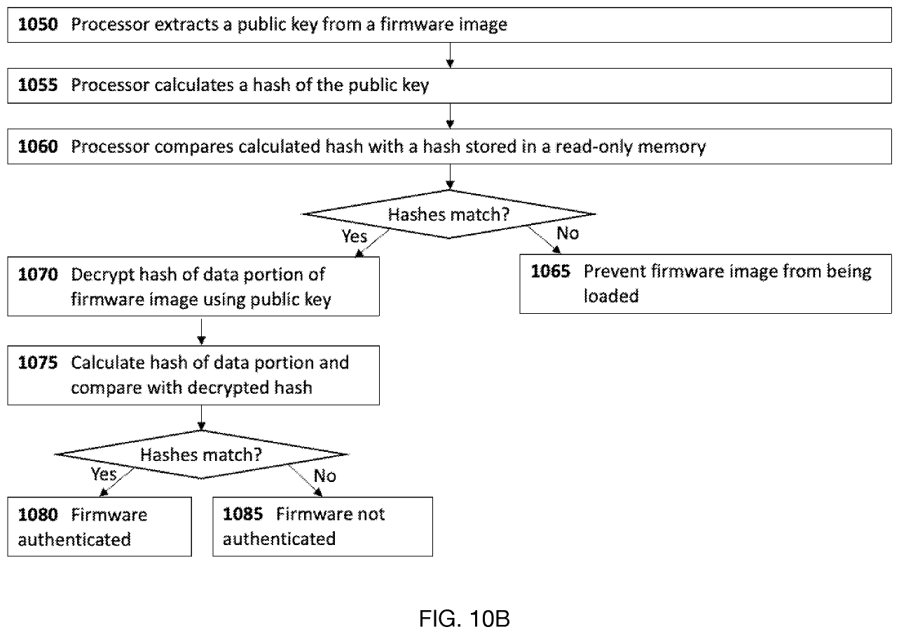

In step 915 the processor authenticates the firmware image using the firmware authentication information. Further information on the authentication process is provided later in connection with FIG. 10B.

The next action of the processor following step 915 depends on whether the authenticating of step 915 is successful. Step 920 is carried out where the authenticating is successful. In step 920, the processor proceeds to reboot the retimer. As part of the rebooting, the processor loads the firmware image and writes at least one vendor-defined instruction definition from the at least one vendor-defined instruction package to a memory of the retimer. The memory could be a memory accessible to the CPU core 200, e.g. data RAM 215 and/or a memory that is accessible to symbol decoder 860.

If the non-volatile memory is partitioned as discussed above, step 920 can also include marking the set of memory addresses that the firmware image has been written to as active before rebooting. The inverse is also performed, i.e. marking the set of memory addresses that the previous firmware image is stored at as inactive. This has the effect of swapping the active and inactive partitions, so that on the next boot the processor will use the firmware image that has been authenticated. The current status of each partition, i.e. active or inactive, can be stored in header 300 (FIG. 3), for example. The header 300 can store the first address of the currently active partition such that the processor will begin reading the firmware from this address on boot.

The marking of one set of memory addresses as active and the other set of memory addresses as inactive can be performed simultaneously as an atomic write operation. That is, the adjustment of both partitions is performed in a single operation. This eliminates the possibility of a failure occurring during the switchover that results in both partitions being marked as inactive or active at the same time, for example, which could occur in the case where the reassignment of the partitions takes place in multiple distinct operations. This atomic operation can be performed as the final action of the firmware update process such that the switch of the partition statuses is only carried out once it is certain that the firmware update has been successful.

In the case where the authenticating is unsuccessful, the processor takes remedial action in step 925. The remedial action could be to prevent the updated firmware from being loaded. The processor may cause the retimer to enter a restricted operation mode corresponding to a suspected security issue. One or more error codes may be transmitted to a host CPU that provided the firmware image. Other actions are additionally or alternatively possible.

Attempting to authenticate the firmware image in step 915 can comprise two distinct actions-checking that the source of the firmware image is genuine and checking that the content of the firmware image has not been modified.

The source of the firmware image can be checked by comparing the firmware authentication information received in step 910 with a firmware authentication data package included in the firmware image. Specifically, the firmware authentication information can include a hash of a public key and the firmware authentication data package can include the public key.

The processor can calculate the hash of the public key extracted from the firmware authentication data package and compare this hash with the firmware authentication information. If these two pieces of data match, then it can be confirmed that the firmware image is from a genuine (i.e. authorised) source. This is because the probability of a hash of some value that is not the public key of an authorised entity matching the hash stored in the read-only memory is vanishingly small. Additionally, as the read-only memory is written in a controlled environment (e.g. by the manufacturer before the retimer is shipped), it can be taken as trusted that the hash value stored in the read-only memory is genuine—i.e. that it is indeed the hash of the public key of an authorised entity.

The content of the firmware image can be checked as follows. The firmware image includes a data portion and an encrypted hash of the data portion. The data portion includes the at least one vendor-defined instruction package discussed above, as well as any one or more of configuration data 310, PHY firmware 315 and application 320. The encrypted hash of the data portion is a hash value of the data portion that has been encrypted by a private key that forms a key pair with the public key discussed above. Any change to the data portion, even a very minor change, will produce a different hash value of the data portion and hence the hash value of the data portion can be used to check for any such modifications.

The hash value of the data portion is encrypted with the private key forming a key pair with the public key to enable it to be verified that the data portion hash value has been provided by an authorised entity. This is because only the authorised entity should have access to the private key. In this way the encrypted hash of the data portion enables the processor to confirm that the data portion has not been tampered with (i.e. modified in some way deliberately) or corrupted in transit. The key pair is asymmetric and can be generated in a secure environment, e.g. a manufacturer closed network, using a key generation algorithm, e.g. RSA-2048.

FIG. 10A shows in schematic form the content of the firmware image and FIG. 10B shows in detail one way in which the process of authenticating the firmware image using the firmware authentication information can be performed.

The firmware image includes a data portion 1000 that includes the at least one vendor-defined instruction package discussed above, as well as any one or more of configuration data 310, PHY firmware 315 and application 320. Data portion 1000 typically represents the majority of the firmware image in terms of size. The firmware image also includes a hash of the data portion that has been encrypted using the private key as discussed above. This is shown as region 1005 in FIG. 10. The firmware image further includes a copy of the public key corresponding to the private key used to encrypt the hash of the data portion. This is shown as region 1010 in FIG. 10. The public key could be 2048 bits, for example, although the disclosure is not limited to this and public keys of other sizes can be used instead.

Referring now to the authentication process of FIG. 10B, in step 1050 the processor extracts public key 1010 from the firmware image and in step 1055 the processor calculates a hash of the public key 1010. The hash can be calculated using the same algorithm as was used to calculate the hash stored in the read-only memory, e.g. the SHA-224 algorithm.

In step 1060 the processor compares the hash calculated in step 1055 with the hash value stored in the read-only memory to determine whether they match. A match indicates that public key 1010 is the same as the public key that was hashed to generate the data stored in the read-only memory, i.e. this proves that public key 1010 is that of an authorised party (e.g. a manufacturer). A mismatch indicates that public key 1010 is not the same as the public key that was hashed to generate the data stored in the read-only memory. This suggests either a corrupt firmware image or deliberate tampering by an unauthorised party. In either case, loading of the firmware image is prevented in the case of a mismatch as shown in step 1065, possibly after one or more attempts at re-receiving the firmware image and repeating step 1060 to take account of the possibility of a transmission error being the cause of the mismatch. Additionally, the authentication process can terminate at this point rather than continuing to perform any subsequent authentication actions, leading to a reduction in the total computations performed in such circumstances.

In the case where step 1060 finds a match, the process continues to step 1070 where public key 1010 is used to decrypt the encrypted hash of the data portion 1005. Public key 1010 can be used to perform this decryption because the positive match identified in step 1060 demonstrates that public key 1010 is authentic. This means that it is not necessary to store the full public key 1010 in the read-only memory-instead, only the hash of the public key needs to be stored in the read-only memory. This can result in a significant saving of space in the read-only memory. For example, in the case of a 2048-bit public key and a SHA-224 hash, the read-only memory is required to store 224 bits instead of 2048-a reduction of approximately 90%. For context, a read-only memory like OTP memory 230 can have a capacity of 1024 bits, with space thus being in relatively short supply.

Additionally, the hash of the data portion is far fewer bits than the data portion itself. This means that decryption of the encrypted hash of the data portion 1005 takes significantly less time than it would take to decrypt the entire data portion 1000. Thus the ability to identify modifications to the data portion is retained without incurring the penalty associated with decrypting the entire data portion 1000.

In step 1075 the processor calculates a hash of data portion 1000 to generate a data portion hash value and then compares the decrypted hash value obtained in step 1070 with the data portion hash value to determine whether they match.

In the case where a match is found in step 1075, the processor authenticates the firmware image (step 1080). At this point it has been confirmed that the firmware image contains genuine, unmodified and uncorrupted firmware that has been supplied by an authorised party (e.g. a manufacturer of the retimer). This is referred to herein as ‘authentic’ firmware. The process then moves to step 925 of FIG. 9.

In the case where a match is not found in step 1075, the processor does not authenticate the firmware image (step 1085). This is because a mismatch between the data portion hash value and the decrypted hash value indicates that the data portion 1000 has been modified in some way compared with the authentic version released by an authorised entity such as the manufacturer. The modification could be deliberate, e.g. an attempt at hacking, or it could be accidental, e.g. a corruption to the firmware. In either case it is desirable to prevent loading of the firmware image and so in these circumstances the processor does not load the firmware image and moves to step 925 of FIG. 9.

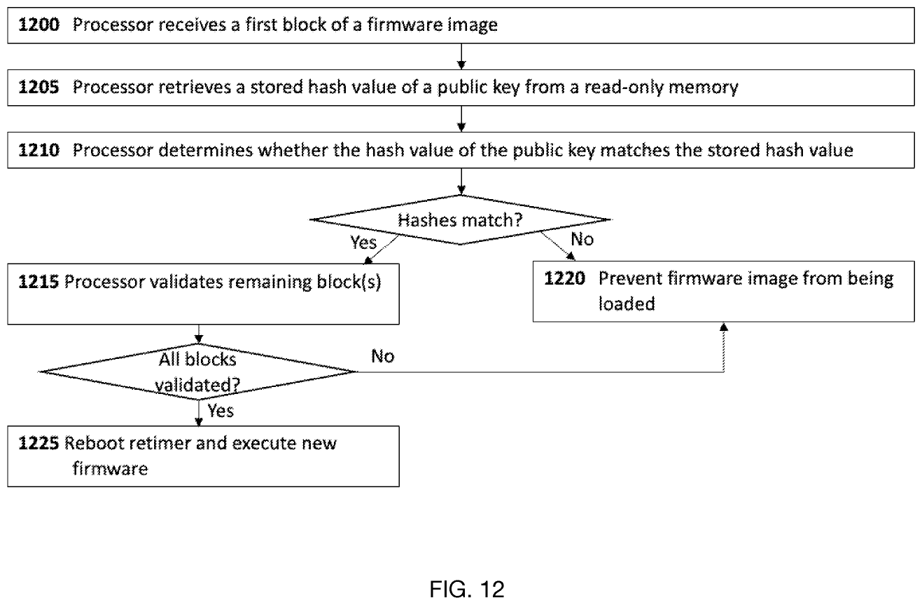

Another process that works on similar principles to that of FIGS. 9 and 10B is shown in FIG. 12. This process implements an on-the-fly hash calculation rather than calculating the hash of the entire firmware image once it has been stored. The on-the-fly hash calculation splits the firmware image up into a series of blocks of some size, e.g. 1 KB, 2 KB, 4 KB, etc. As each block is received a hash of the block is calculated and compared to a hash transmitted with the block. If the hashes match, the block is treated as valid and is written to the non-volatile memory. A mismatch in hashes indicates either a transmission error or an attempt to modify the firmware.

The process of FIG. 12 can be used instead of the process of FIGS. 9 and 10B to validate and authenticate a firmware image. Additional features described above in connection with FIGS. 9 and 10B can thus equally be applied to the process of FIG. 12.

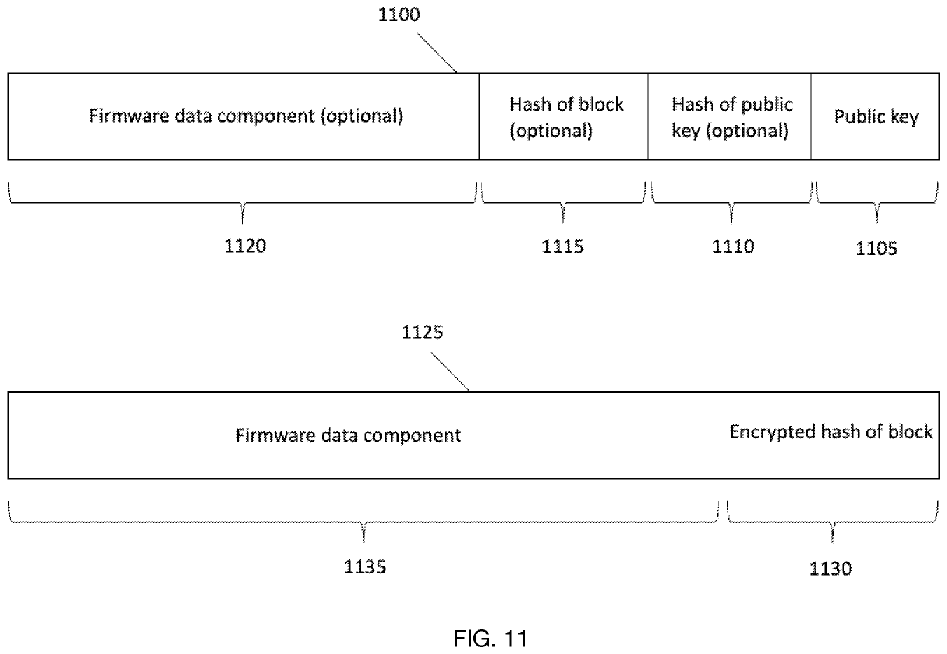

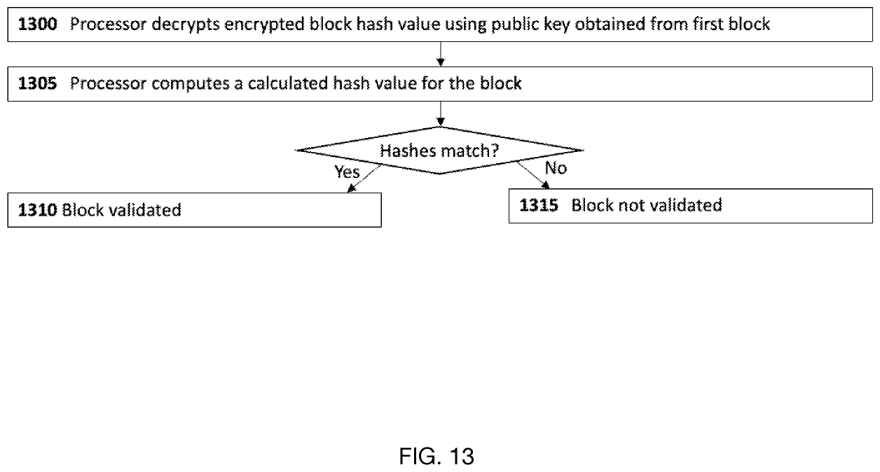

FIG. 11 shows an example of a first block and also a subsequent block in schematic form, while FIGS. 12 and 13 provide further details about the on-the-fly hash calculation process. The process described in connection with FIGS. 11 to 13 can be implemented as part of a retimer firmware update procedure, for example.

FIG. 11 shows in schematic form the construction of the first block 1100 in a firmware update data package. The firmware update data package comprises the first block and one or more subsequent or ‘remaining’ blocks. The firmware update data package includes a firmware image and also additional information that enables the firmware image to be authenticated and validated.

First block 1100 includes a public key 1105. This is the public key provided by the issuer of the firmware update data package that purports to be authentic. The process of FIG. 12 can determine whether this public key is in fact authentic.

First block 1100 can also include a hash 1110 of the public key 1105. This is not strictly necessary as it is possible for the retimer processor to instead calculate a hash of the public key using public key 1105. If present, the hash 1110 may be encrypted using a private key corresponding to public key 1105.

First block 1100 can additionally or alternatively include a firmware data component 1120 and an encrypted hash of the block 1115. The firmware data component 1120, if present, includes part of the firmware image that is to be written to the non-volatile memory of the retimer. It is not necessary for the first block to include any firmware data but it may be desirable to do so in the interests of efficient use of space. This is because the public key 1105, and hash 1110 if present, are typically smaller than the total size of a block, meaning that some space is usually left unused in first block 1100 if the firmware data component 1120 is not present. The encrypted hash 1115 is included for block validation purposes-see below for further information.

FIG. 11 is not exhaustive as other data can be included in first block 1100. Examples include: a request for the retimer to perform an update; a sequence number; a total number of blocks that the retimer should expect to receive, etc.

FIG. 11 also shows in schematic form the construction of a subsequent block 1125. The subsequent block 1125 includes an encrypted hash of the block 1130 and a firmware data component 1135. The encrypted hash 1130 is encrypted using the private key corresponding to the public key 1105 transmitted with the first block 1100. The encrypted hash 1130 is thus decryptable using public key 1105. This prevents an unauthorised third party from switching a valid hash with a hash corresponding to a modified block, as the modified block hash cannot be correctly encrypted using the private key as this is not available to the third party. An attempt to decrypt a modified hash using public key 1105 would thus fail. These principles apply equally to encrypted hash 1115, if present in the first block 1100.

The firmware data component 1135 is part of the firmware image that is ultimately to be loaded by CPU core 200 (assuming the firmware image is authentic). It will thus be appreciated that some number of subsequent blocks, including one subsequent block, is/are needed to fully transfer the firmware image to the retimer. The total number of blocks required will depend on the size of the firmware image and the size of each block.

Collectively, the blocks all form the firmware update package discussed above that includes at least one vendor-defined instruction package.

FIG. 11 is not exhaustive as other data can be included in the subsequent block 1125. Examples include: information about the block type (e.g. a firmware data component carrying block); a sequence number; a size of the firmware data component 1135, etc.

The terms ‘first block’ and ‘subsequent block’ are used to distinguish these two different block types. This does not imply that the first block necessarily must be received by the retimer before the subsequent blocks. Indeed, the blocks can be received in any order, e.g. stored in a buffer, and then processed as described herein. The first block is characterised by containing the public key (and possibly also the hash thereof), whereas subsequent blocks do not contain the public key and hash of the public key.

Referring now to FIG. 12, a process for authenticating a firmware update package is described. In step 1200, a processor of the retimer receives a first block of a firmware update package (e.g. first block 1100). This first block can be received from any source external to the retimer, e.g. from a host CPU. The first block comprises a public key 1105. The first block can also comprise a hash of the public key 1110 and/or an encrypted hash of the first block 1115 that has been encrypted using a private key corresponding to the public key 1105.

In step 1205, the processor retrieves a stored hash value of a public key from a read-only memory of the retimer. The stored hash value could be retrieved from OTP memory 230, for example. It is specifically stated here that ‘a stored hash value of a public key’ is retrieved because at this point it is not known whether the public key corresponding to the stored hash value is the same as the public key transmitted with the first block.

In step 1210, the processor compares a hash value of the public key with the stored hash value. In the case where the hash value of the public key was included in the first block, a comparison can be carried out directly. The hash value may be encrypted and so it may be necessary to decrypt the hash value using the public key. In the case where the hash value of the public key was not included in the first block, step 1210 includes calculating the hash value of the public key as received in the first block to make this available for comparison with the stored hash value.

The processor determines whether the hash value of the public key matches the stored hash value. In the case that there is a match (e.g. the hashes are identical to one another), this indicates that the public key included with the first block is a genuine public key. The processor can therefore trust that the firmware image has originated from an authorised source such as a manufacturer. However, at this point the security check has not finished as it has not been ruled out that the firmware image itself is unmodified since being issued by the authorised source. In this case, the process moves to step 1215.

In the case where the processor does not find a match, this indicates either a corrupted first block or an attempt by an unauthorised party to load unauthorised firmware onto the retimer. In this case the firmware is prevented from being loaded, e.g. by halting the firmware update process (step 1220). Step 1220 could include re-sending the first block one or more times and re-performing step 1210 to eliminate the possibility of a first block corrupted due to a transaction error causing the hash value mismatch.

In step 1215, the processor receives a remainder of the firmware update data package as one or more further blocks (e.g. all of these blocks being like subsequent block 1125). That is, if the entire firmware update data package including the first block is k blocks, k-1 blocks are received in step 1215. Each block is validated as it is received and stored in the non-volatile memory (e.g. SPI flash 240). Validation refers to checking that the block is a valid block, i.e. that the content of the block can be treated as originating from an authorised entity.

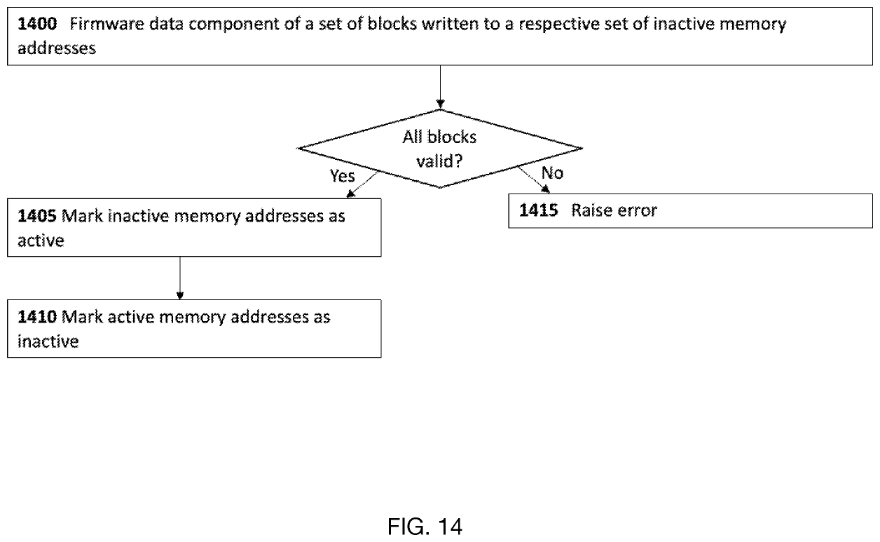

FIG. 13 shows a block validation process that can be performed as part of step 1215 and FIG. 14 shows a block storage process that can be used to store each block in the non-volatile memory.

In the case where validation of a block fails, the process moves to step 1220 in which the processor prevents the firmware image from being loaded. As above, before moving to step 1220, the processor may request the re-sending of a block that was not validated one or more times to account for transmission errors. Prevention of the firmware image being loaded could include ceasing to accept further blocks, i.e. halting the download of the firmware update data package.

In the case where all blocks have been successfully validated, the process moves to step 1225. In step 1225, the processor reboots the retimer. The reboot includes the processor loading the firmware image from the non-volatile memory and writing at least one VD instruction definition obtained from the firmware image to a memory of the retimer. This memory could be a memory accessible to CPU core 200 such as data RAM 215, for example, and/or the memory could be a memory or register accessible to symbol decoder 860, for example. At this point, the firmware update process is complete and the retimer is now running a new firmware version that includes one or more updated VD instruction definitions. The retimer can be confident that it is running authentic firmware because each block has been successfully validated before rebooting the retimer. The firmware update image in this case is formed of the firmware data components 1125 from each of the one or more further blocks.

The description above assumes that the first block does not contain a firmware data component and so does not need validating. However, in some cases the first block can also include a firmware data component like firmware data component 1120 and thus also requires validation. In such cases the first block can also be validated using hash 1115 in the same way as the other blocks are validated. In this case, the firmware update image is formed of the firmware data components 1125 from each of the one or more further blocks and a firmware data component 1120 from the first block 1100.

Referring now to FIG. 13, this shows in detail a process for validating a block. This process can form part of step 1215. In this process, each block of the remainder of the firmware image includes an encrypted block hash value 1130 corresponding to the block and encrypted using a private key corresponding to the public key that is included in the first block. In the case where the first block includes firmware data component 1120, the first block can also include an encrypted block hash value 1115 corresponding to the first block. The process of FIG. 13 can thus be performed k-1 or k times, depending on whether the first block includes part of the firmware image.

In step 1300, the processor decrypts the encrypted block hash value stored within the block using the public key 1105 to obtain a decrypted block hash value. It is noted that by this point the public key validity has already been confirmed (see step 1210 of FIG. 12) and it is therefore acceptable to trust the public key in this validation process.

It is noted that if the decryption performed in step 1300 fails, this indicates either a corrupt block or an invalid block. The processor can request re-transmission of the block one or more times to address any transmission errors that could have caused the block to become corrupt. If the block hash still cannot be decrypted after re-transmission, the block is deemed invalid. Re-transmission is optional and does not need to be performed as the processor can deem a block invalid without re-transmission in the event of a decryption failure.

In step 1305, the processor computes a calculated hash value for the block. A hash algorithm such as SHA-224 can be used to calculate the hash value. This is not limiting on the scope of this disclosure as other hash algorithms such as SHA-256 can alternatively be used.

It will be appreciated that the order of steps 1300 and 1305 can be reversed, or these steps can be performed in parallel, without departing from the scope of this disclosure.

The processor determines whether the calculated hash value for the block matches the hash value decrypted in step 1300. In the case where a match is found (e.g. the calculated hash value and decrypted hash value are identical), the block is validated (step 1310). In the case where a match is not found, the block is deemed invalid (step 1315). The processor can request re-transmission of the block one or more times to address any transmission errors that may have caused the mismatch. If the decrypted block hash still cannot be matched to the calculated hash, the block is deemed invalid. Re-transmission is optional and does not need to be performed as the processor can deem a block invalid without re-transmission in the event of a hash mismatch.

The process of FIG. 13 can increase security as it prevents an unauthorised third party from replacing a block with a modified block that includes a re-calculated (and hence accurate) hash for the modified block. This is because the unauthorised third party does not have access to the private key necessary to encrypt the hash value such that it can be decrypted by the public key. Thus, in the case where an unauthorised third party does replace a block, the decryption of step 1200 will fail and this failure will alert the processor to the possibility of the firmware image having been tampered with. The third party cannot circumvent this check by inserting their own public key in the first block in place of public key 1105 because in this case the hash of the public key will not match the hash stored in the read-only memory. Thus, it will be detected that the public key is invalid and the firmware update process will again be halted.

Storing a block in the non-volatile memory (e.g. SPI flash 240), as performed in step 1215, can be carried out according to the process of FIG. 14. The block that is stored according to the process of FIG. 14 can be the first block and/or any one or more of the subsequent block(s).

In step 1400, the firmware data component of the block is written to a respective set of memory addresses of the non-volatile memory that are marked as inactive. Referring to FIG. 3, the set of memory addresses could reside in a memory address range assigned to inactive firmware image 325. Header 300 can store address range details, e.g. the addresses and/or address range(s) that are currently marked active and the addresses and/or address range(s) that are currently marked inactive.

Step 1400 is repeated for as many blocks as are received that contain a firmware data component. Depending on whether the first block includes a firmware data component, step 1400 can therefore be repeated k or k-1 times. Step 1400 may be repeated fewer than k or k-1 times if an invalid block is discovered, or it may be repeated more than k-1 or k times if a transmission error requires a block to be re-written.

In the case where validation of all blocks was successful, i.e. the firmware image is considered valid and authentic, the process moves to step 1405. In step 1405, the set of memory addresses that the blocks were written to in step 1400 (e.g. inactive firmware image 325) are marked as active. This can involve altering data stored in header 300 such that header 300 records the memory addresses written to in step 1400 as active.

In step 1410, a second set of memory addresses of the non-volatile memory that correspond to memory locations at which a previous version of the firmware image is stored are marked as inactive. This could be active firmware image 305 (FIG. 3). As above, the active/inactive designation can be stored in header 300 and so step 1410 can include altering data in header 300 such that header 300 records memory addresses not written to in step 1400 but which hold firmware data as inactive. The previous version of the firmware image can be the firmware image that was most recently used to boot the retimer, i.e. the firmware image that CPU core 200 is currently running.

It is possible to perform steps 1405 and 1410 simultaneously via an atomic write operation. This avoids the scenario where an error (e.g. power failure) occurs between changing the designation of one partition and changing the designation of the other. A situation in which both partitions are marked as active or inactive simultaneously is thus avoided if an atomic write update operation is performed.

Steps 1405 and 1410 can be performed as the final action of a firmware update process. This means that only once the entire update has been performed correctly and successfully is the newly stored firmware image designated ‘active’. This reduces the likelihood of an error that occurs during the firmware update process resulting in a retimer that cannot boot.

In the case where validation of all blocks was not successful, an error is reported (step 1415). This can involve raising an interrupt request for CPU core 200 or a host CPU to handle. Notably, the memory addresses written to in step 1400 are still marked as inactive in this case, meaning that they will not be used on boot. This prevents the retimer from booting using invalid firmware.

FIG. 15 shows in more detail the usage of VD instructions to enable a retimer to perform skew detection and correction. An upstream component (UC) 1500 is communicatively coupled to a downstream component (DC) 1505 via a first retimer 1510 and a second retimer 1515. The UC could be a root complex or switch, and the DC could be a switch or endpoint, for example.

Each retimer 1510, 1515 includes four pseudo-ports, numbered 0 to 3. Pseudo-ports 0 and 1 are upstream-facing in each case, and pseudo-ports 2 and 3 are downstream-facing in each case. UC 1500 and DC 1505 are in communication with one another via two lanes 1520, 1525. During link setup it has been established that lane 1520 couples port A of UC 1500 to port C of DC 1505, and that lane 1525 couples port B of UC 1500 to port D of DC 1505. UC and DC thus expect this port mapping to exist until the link that comprises lanes 1520, 1525 is terminated or the mapping is adjusted.

Each retimer 1510, 1515 can include a delay buffer (not shown) for each lane of traffic. The delay buffer enables a delay of a specific number of clock cycles to be introduced to the lane that it is associated with. The delay buffer could be implemented by a plurality of pipeline flip-flops, where the number of flip-flops that are in use at a given time is selected by a control signal. It is possible to at least reduce a lane-to-lane skew using the delay buffer by delaying a faster lane by a number of clock cycles equal to the lane-to-lane skew. This enables symbols transmitted over a slower lane to ‘catch up’ with symbols transmitted over a faster lane, such that at the output of the retimer the lanes are in sync, or at least less skewed. Delay buffer settings can be exchanged between components of FIG. 15 using VD instructions, e.g. between retimer 1510 and retimer 1515. This can be combined with lane routing information to enable skew reduction with reduced latency. The VD instructions can be contained within control skip ordered-sets as discussed earlier.

FIG. 15 also shows the physical carriers (e.g. circuit traces) that carry signals between the various components shown. Specifically: carrier C1 couples port A of UC 1500 to port 0 of retimer 1510, carrier C2 couples port B of UC 1500 to port 1 of retimer 1510, carrier C3 couples port 2 of retimer 1510 to port 0 of retimer 1515, carrier C4 couples port 3 of retimer 1510 to port 1 of retimer 1515, carrier C5 couples port 2 of retimer 1515 to port C of DC 1505 and carrier C6 couples port 3 of retimer 1515 to port D of DC 1505.

Channels C1 to C6 can be grouped into pairs: C1 and C2; C3 and C4; C5 and C6. Each pair of channels carries signals between the same pair of components, e.g. C1 and C2 each carry signals between UC 1500 and retimer 1510.

In a configuration shown in FIG. 15 where there are at least two intermediate components (i.e. retimers 1510, 1515) between UC 1500 and DC 1505, it is possible to perform silent lane routing between the retimers to at least reduce the lane-to-lane skew in a link. The term ‘silent’ is used here because neither UC 1500 nor DC 1505 are aware of this routing, as it takes place in a manner that is transparent to both of these components. This process can also be referred to as ‘link de-skewing’, or ‘passive link de-skewing’.

Retimers 1510 and 1515 determine the skew associated with each lane and take action to correct this skew. The retimers co-ordinate by exchanging skew information using VD instructions. The VD instruction can be contained within control skip ordered-sets as discussed earlier. The objective is to have as little skew as possible between lanes (ideally, none). The exchange of skew information using VD instructions between the retimers enables the retimers to understand the inherent skew of channels C3 and C4. This means that retimers 1510, 1515 can select a mapping that counteracts, at least to some degree, skew introduced by other channels and components. The mapping can be implemented by controlling MUX 700 in each retimer 1510, 1515 such that the required lane routing is achieved.

The essence of this concept is that a lane with greater skew should be routed over a faster path between the retimers and a lane with lesser skew should be routed over a slower path between the retimers. That is, a faster lane is routed via a slower path, and vice versa. This has the effect of delaying symbol arrival time for the faster lane relative to a routing path that does not take this information into account, and similarly expediting symbol arrival time for the slower lane relative to a routing path that does not take this information into account. The result is a closer aligned symbol arrival time between the lanes, i.e. reduced lane-to-lane skew.

This technique functions because the routing between UC 1500 and retimer 1510 is set when UC 1500 and DC 1505 perform link establishment, as is the routing between retimer 1515 and DC 1505. However, the routing between the retimers themselves is not fixed by this because any routing change made by one retimer can be reversed by the other without either UC 1500 or DC 1505 requiring knowledge of this routing change.

It will be appreciated that more pseudo-ports can be present than illustrated in FIG. 15. In such a case, silent routing can be performed over more than 2 lanes. In general, the silent routing configuration is identified by determining the routing configuration that results in the smallest link skew.

One area in which the silent routing techniques described above have utility in a ‘low latency’ retimer operation mode in which the latency introduced by each retimer is desired to be minimal. In this operating mode, each retimer would introduce significant latency if operating in a full retiming mode that includes active lane de-skew. Instead, silent lane routing as discussed above can be used to de-skew (at least to some extent) without introducing any significant latency to the link.

Although two retimers have been shown in FIG. 15 as implementing the silent de-skew techniques disclosed above, the disclosure is not restricted to this as any component that is capable of implementing the silent skew correction teaching set out above can alternatively be used in place of a retimer. This includes redrivers and also switches that incorporate the ability to perform silent skew correction.

It is possible to combine silent de-skew with delay buffer-based skew correction by sharing lane skew information using VD instructions. In this case the delay of the delay buffer can be set with knowledge of the de-skewing effect introduced by the silent lane routing. This can reduce the overall latency of the link because the delay of a delay buffer can be set deliberately less than is necessary to entirely remove skew, in the knowledge that the remaining skew will be removed by the inherent skew of channels C3 and C4 under the silent lane routing configuration.

It is possible to define pre-set delay buffer settings and/or pre-set silent lane routing configurations. Measurements can be made in a laboratory or other such ‘non deployed’ setting and typical skew values can be calculated for each lane. A skew can be measured for each of a set of possible links, e.g. ax1, x2, x4, x8 and x16 PCIe link, with a given hardware configuration (i.e. particular UC 1500, DC 1505, retimers 1510, 1515). The delay buffer settings for each delay buffer on each retimer can be saved in a memory such as SPI flash 240 and loaded according to the particular link configuration that is currently active. Similarly, a silent lane routing configuration for each link configuration can be saved in a memory such as SPI flash 240 and loaded according to the particular link configuration that is currently active. The saved configuration can either be used as is, or it can be used as a base configuration that is fine-tuned during a link establishment process.

It is possible to add new pre-set delay buffer settings and/or silent link configurations to a retimer in the field by providing updated firmware with the updated settings. The firmware update can be performed according to any of the techniques discussed above.

In addition to the embodiments described above, the following clauses set out additional embodiments of the disclosure.
Clause 1: A method, comprising: receiving, by a processor of a Peripheral Component Interconnect express (PCIe) retimer, a first block of a firmware update data package, the first block comprising a public key, and the firmware update data package comprising at least one vendor-defined instruction package; retrieving, by the processor, a stored hash value of a public key from a read-only memory of the retimer; comparing, by the processor, a hash value of the public key with the stored hash value to find a match; responsive to finding a match, receiving a remainder of the firmware update data package as one or more further blocks, each of the one or more further blocks including a firmware data component; validating the one or more further blocks; storing the firmware data component of each of the one or more further blocks in a non-volatile memory of the retimer; and rebooting the retimer, the rebooting including: loading a firmware image from the non-volatile memory, the firmware image comprising the firmware data component of each of the validated one or more further blocks; and writing at least one vendor-defined instruction definition obtained from the vendor-defined instruction package to a definition library of the retimer.
Clause 2: The method of clause 1, wherein each of the one or more further blocks includes a respective encrypted block hash value corresponding to the block and encrypted using a private key corresponding to the public key, and wherein validating the one or more further blocks includes, for each block of the one or more further blocks, the processor: decrypting the encrypted block hash value stored within the block using the public key to obtain a decrypted block hash value; computing a calculated hash value of the block; and validating the block in the case where the calculated hash value matches the decrypted block hash value.
Clause 3: The method of any preceding clause, wherein storing the firmware data component of each of the one or more further blocks in a non-volatile memory of the retimer further comprises: writing the firmware data component of each of the one or more further blocks to a respective set of memory addresses of the non-volatile memory that are marked as inactive; and wherein the method further comprises: marking the set of memory addresses as active; and marking a second set of memory addresses of the non-volatile memory that correspond to memory locations at which a previous version of the firmware image is stored as inactive.
Clause 4: The method of clause 3, wherein marking the set of memory addresses as active and marking the second set of memory addresses as inactive are performed simultaneously as an atomic write operation.
Clause 5: The method of any preceding clause, wherein the first block includes a firmware data component and an encrypted first block hash value corresponding to the first block and encrypted using a private key corresponding to the public key, and wherein the method further comprises the processor: decrypting the encrypted first block hash value stored within the first block using the public key to obtain a decrypted first block hash value; computing a calculated first block hash value of the first block; validating the first block responsive to the calculated first block hash value matching the decrypted first block hash value; and responsive to the validating, storing the firmware data component of the first block in the non-volatile memory.
Clause 6: The method of clause 5, wherein storing the firmware data component of the first block in the non-volatile memory further comprises: writing the firmware data component of the first block to a set of memory addresses of the non-volatile memory that are marked as inactive.
Clause 7: The method of any preceding clause, further comprising: detecting, by a symbol decoder of the retimer, a control skip ordered-set in a data stream of the retimer, the control skip ordered-set including one or more vendor-defined bytes storing information corresponding to a vendor-defined instruction definition of the at least one vendor-defined instruction definition; writing, by the symbol decoder, status data to a status register of the retimer, the status data based on the one or more vendor-defined bytes; and raising, by the symbol decoder, an interrupt request for handling by the processor.
Clause 8: The method of clause 7, further comprising: responsive to the interrupt request, reading, by the processor, the status data from the status register; and changing, by the processor, an operating mode of the retimer based on the status data.
Clause 9: The method of any one of clauses 1 to 6, further comprising: detecting, by a symbol decoder of the retimer, a control skip ordered-set in a data stream of the retimer, the control skip ordered-set including one or more vendor-defined bytes storing information corresponding to a vendor-defined instruction definition of the at least one vendor-defined instruction definition specifying a delay buffer configuration setting; and applying the delay buffer configuration setting to at least one delay buffer of the retimer.
Clause 10: The method of any one of clauses 1 to 6, or clause 9, further comprising: detecting, by a symbol decoder of the retimer, a control skip ordered-set in a data stream of the retimer, the control skip ordered-set including one or more vendor-defined bytes storing information corresponding to a vendor-defined instruction definition of the at least one vendor-defined instruction definition specifying a retimer routing configuration setting; and mapping upstream pseudo-ports of the retimer to downstream pseudo-ports of the retimer based on the retimer routing configuration setting.
Clause 11: A method, comprising: receiving, by a processor of a peripheral component interconnect express (PCIe) retimer, a firmware image including at least one vendor-defined instruction package; writing, by the processor, the firmware image to a non-volatile memory; retrieving, by the processor, firmware authentication information from a read-only memory of the retimer; authenticating, by the processor, the firmware image using the firmware authentication information; and rebooting the retimer, wherein as part of the rebooting the processor loads the firmware image and writes at least one vendor-defined instruction definition obtained from the at least one vendor-defined instruction package to a definition library of the retimer.
Clause 12: The method of clause 11, wherein the firmware authentication information comprises a first hash of a first public key, and wherein authenticating the firmware image using the firmware authentication information further comprises: extracting a second public key from the firmware image; calculating a second hash of the second public key; and comparing the first hash with the second hash to determine whether they match.
Clause 13: The method of clause 12, wherein the firmware image includes a data portion and an encrypted hash of the data portion, the encrypted hash of the data portion encrypted using a private key of a key pair also comprising the second public key, and wherein authenticating the firmware image using the firmware authentication information further comprises: decrypting the encrypted hash of the data portion of the firmware image using the second public key to generate a decrypted hash value; calculating a hash of the data portion of the firmware image to generate a data portion hash value; comparing the decrypted hash value with the data portion hash value to determine a match; and responsive to determining a match, authenticating the firmware image.
Clause 14: An apparatus, comprising: a Peripheral Component Interconnect express (PCIe) retimer comprising a processor coupled to a read-only memory of the retimer and to a non-volatile memory of the retimer, wherein the processor is configured to: receive a first block of a firmware update data package, the first block comprising a public key and the firmware update package comprising at least one vendor-defined instruction package; retrieve a stored hash value of a public key from the read-only memory; compare a hash value of the public key with the stored hash value and, in the case of a match, proceed to: receive a remainder of the firmware update data package as one or more further blocks, each of the one or more further blocks including a firmware data component; validate the one or more further blocks; store the firmware data component of each of the one or more further blocks in the non-volatile memory; and reboot the retimer, the reboot including: loading a firmware image from the non-volatile memory, the firmware image comprising the firmware data component of each of the validated one or more further blocks; and writing at least one vendor-defined instruction definition obtained from the vendor-defined instruction package to a definition library of the retimer.
Clause 15: The apparatus of clause 14, wherein each of the one or more further blocks includes a respective encrypted block hash value corresponding to the block and encrypted using a private key corresponding to the public key, and wherein the processor is configured to validate the one or more further blocks by, for each block of the one or more further blocks: decrypting the encrypted block hash value stored within the block using the public key to obtain a decrypted block hash value; computing a calculated hash value of the block; and validating the block in the case where the calculated hash value matches the decrypted block hash value.
Clause 16: The apparatus of clause 14 or clause 15, wherein the processor is configured to store the firmware data component of each of the one or more further blocks in a non-volatile memory of the retimer by: writing the firmware data component of each of the one or more further blocks to a respective set of memory addresses of the non-volatile memory that are marked as inactive; and, in the case that the validation is successful: marking the set of memory addresses as active; and marking a second set of memory addresses of the non-volatile memory that correspond to memory locations at which a previous version of the firmware image is stored as inactive.
Clause 17: The apparatus of any one of clauses 14 to 16, wherein the first block includes a firmware data component and an encrypted first block hash value corresponding to the first block and encrypted using a private key corresponding to the public key, and wherein the processor is further configured to: decrypt the encrypted first block hash value stored within the first block using the public key to obtain a decrypted first block hash value; compute a calculated first block hash value of the first block; validate the first block in the case where the calculated first block hash value matches the decrypted first block hash value; and in the case where the first block is validated, store the firmware data component of the first block in the non-volatile memory.
Clause 18: The apparatus of any one of clauses 14 to 17, wherein the retimer further comprises a status register and a symbol detector, the symbol decoder configured to: detect a control skip ordered-set in a data stream of the retimer, the control skip ordered-set including one or more vendor-defined bytes storing information corresponding to a vendor-defined instruction definition of the at least one vendor-defined instruction definition; write status data to the status register, the status data based on the one or more vendor-defined bytes; and raise an interrupt request for handling by the processor.
Clause 19: The apparatus of any one of clauses 14 to 17, wherein the retimer further comprises a status register and a symbol decoder, the symbol decoder configured to: detect a control skip ordered-set in a data stream of the retimer, the control skip ordered-set including one or more vendor-defined bytes storing information corresponding to a vendor-defined instruction definition of the at least one vendor-defined instruction definition specifying a delay buffer configuration setting; and wherein the processor is further configured to apply the delay buffer configuration setting to at least one delay buffer of the retimer.
Clause 20: The apparatus of any one of clauses 14 to 17, or clause 19, wherein the retimer further comprises a plurality of upstream pseudo-ports, a plurality of downstream pseudo-ports, a status register and a symbol decoder, the symbol decoder configured to: detect a control skip ordered-set in a data stream of the retimer, the control skip ordered-set including one or more vendor-defined bytes storing information corresponding to a vendor-defined instruction definition of the at least one vendor-defined instruction definition specifying a retimer routing configuration setting; and wherein the processor is further configured to map respective ones of the plurality of upstream pseudo-ports to respective ones of the plurality of downstream pseudo-ports based on the retimer routing configuration setting.

It will be apparent to a person skilled in the art having the benefit of the present disclosure that various modifications, extensions, substitutions and the like to the subject matter described herein are possible. Such changes are also within the scope of this disclosure. It is also noted that, where method steps are described, these steps can be performed in any order unless expressly stated otherwise.

1. A Peripheral Component Interconnect express (PCIe) retimer, comprising:
one or more Physical Layer Circuits (PHYs) configured to receive a PCIe data stream;
a symbol detector configured to detect an in-band retimer message embedded in one or more control symbols within the PCIe data stream; and
data package extraction logic configured to, responsive to the in-band retimer message, monitor the PCIe data stream subsequent to the in-band retimer message to detect a plurality of data package bits and write the data package bits to a memory of the retimer.

2. The PCIe retimer of claim 1, wherein the one or more control symbols comprise control skip ordered sets, and wherein the data package extraction logic comprises the symbol detector configured to monitor the PCIe data stream by detecting one or more additional control skip ordered sets and to obtain the plurality of data package bits from the one or more additional control skip ordered sets.

3. (canceled)

4. The PCIe retimer of claim 1, wherein the one or more control symbols comprise training ordered sets, and wherein the data package extraction logic comprises the symbol detector configured to monitor the PCIe data stream by detecting one or more additional training ordered sets and to obtain the plurality of data package bits from the one or more additional training ordered sets.

5. (canceled)

6. The PCIe retimer of claim 1, further comprising a physical coding sublayer (PCS) receiver configured to receive the PCIe data stream and to decode the PCIe data stream to generate a PCS-decoded data stream, wherein the data package extraction logic is configured to monitor the PCS-decoded data stream to detect the plurality of data package bits, wherein the symbol detector is configured to detect the in-band retimer message by identifying a pattern of bits in the PCS-decoded data stream corresponding to a vendor-defined instruction definition stored in a definition library accessible to the symbol detector, where the vendor-defined instruction definition is associated with the in-band retimer message.

7. (canceled)

8. The PCIe retimer of claim 1, wherein the symbol detector is configured to detect the in-band retimer message by identifying a pattern of bits in the PCIe data stream corresponding to a vendor-defined instruction definition stored in a definition library accessible to the symbol detector, where the vendor-defined instruction definition is associated with the in-band retimer message.

9. The PCIe retimer of claim 1, wherein the one or more control symbols comprise control skip ordered sets and the data package extraction logic comprises a transaction layer packet decoder configured to decode one or more transaction layer packets received in the PCIe data stream subsequent to the in-band retimer message to obtain the plurality of data package bits.

10. The PCIe retimer of claim 9, wherein the symbol detector is configured to detect the in-band retimer message by identifying a pattern of bits in the PCIe data stream corresponding to a vendor-defined instruction definition stored in a definition library accessible to the symbol detector, where the vendor-defined instruction definition is associated with the in-band retimer message.

11. The PCIe retimer of claim 1, further comprising a physical coding sublayer (PCS) receiver configured to receive the PCIe data stream and to decode the PCIe data stream to generate a PCS-decoded data stream, and wherein the one or more control symbols comprise control skip ordered sets and the data package extraction logic comprises a transaction layer packet decoder configured to decode one or more transaction layer packets received in the PCS-decoded data stream subsequent to the in-band retimer message to obtain the plurality of data package bits.

12. The PCIe retimer of claim 11, wherein the symbol detector is configured to detect the in-band retimer message by identifying a pattern of bits in the PCS-decoded data stream corresponding to a vendor-defined instruction definition stored in a definition library accessible to the symbol detector, where the vendor-defined instruction definition is associated with the in-band retimer message.

13. (canceled)

14. The PCIe retimer of claim 1, wherein the data package is a firmware update data package, and wherein the firmware update data package contains at least one vendor-defined instruction definition associated with an in-band retimer message.

15. (canceled)

16. A method, comprising:
receiving, by one or more Physical Layer Circuits (PHYs) of a Peripheral Component Interconnect express (PCIe) retimer, a PCIe data stream;
detecting, by a symbol detector of the PCIe retimer, an in-band retimer message embedded in one or more control symbols within the PCIe data stream;
monitoring, by data package extraction logic of the PCIe retimer and responsive to the detecting of the in-band retimer message, the PCIe data stream to detect a plurality of data package bits; and
writing, by the data package extraction logic, the plurality of data package bits to a memory of the retimer.

17. The method of claim 16, wherein the one or more control symbols comprise control skip ordered sets, wherein the monitoring by the data package extraction logic further comprises the symbol detector monitoring the PCIe data stream by detecting one or more additional control skip ordered sets and obtaining the plurality of data package bits from the one or more additional control skip ordered sets.

18. (canceled)

19. The method of claim 16, wherein the one or more control symbols comprise training ordered sets, wherein the monitoring by the data package extraction logic further comprises the symbol detector monitoring the PCIe data stream by detecting one or more additional training ordered sets and obtaining the plurality of data package bits from the one or more additional training ordered sets.

20. (canceled)

21. The method of claim 16, further comprising a physical coding sublayer (PCS) receiver receiving the PCIe data stream and decoding the PCIe data stream to generate a PCS-decoded data stream, and wherein the monitoring by the data package extraction logic further comprises monitoring the PCS-decoded data stream to detect the plurality of data package bits, wherein the detecting by the symbol detector further comprises identifying a pattern of bits in the PCS-decoded data stream corresponding to a vendor-defined instruction definition stored in a definition library accessible to the symbol detector, where the vendor-defined instruction definition is associated with the in-band retimer message.

22. (canceled)

23. The method of claim 16, wherein the detecting by the symbol detector further comprises identifying a pattern of bits in the PCIe data stream corresponding to a vendor-defined instruction definition stored in a definition library accessible to the symbol detector, where the vendor-defined instruction definition is associated with the in-band retimer message.

24. The method of claim 16, wherein the one or more control symbols comprise control skip ordered sets and the data package extraction logic comprises a transaction layer packet decoder, the method further comprising:
decoding, by the transaction layer packet decoder, one or more transaction layer packets received in the PCIe data stream subsequent to the in-band retimer message to obtain the plurality of data package bits, and wherein the detecting by the symbol detector further comprises identifying a pattern of bits in the PCIe data stream corresponding to a vendor-defined instruction definition stored in a definition library accessible to the symbol detector, where the vendor-defined instruction definition is associated with the in-band retimer message.

25. (canceled)

26. The method of claim 16, wherein the one or more control symbols comprise control skip ordered sets and the data package extraction logic comprises a transaction layer packet decoder, the method further comprising:
a physical coding sublayer (PCS) receiver receiving the PCIe data stream and decoding the PCIe data stream to generate a PCS-decoded data stream; and
the transaction layer packet decoder decoding the one or more transaction layer packets received in the PCS-decoded data stream subsequent to the in-band retimer message to obtain the plurality of data package bits.

27. The method of claim 26, further comprising the symbol detector detecting the in-band retimer message by identifying a pattern of bits in the PCS-decoded data stream corresponding to a vendor-defined instruction definition stored in a definition library accessible to the symbol detector, where the vendor-defined instruction definition is associated with the in-band retimer message.

28. The method of claim 16, wherein the PCIe retimer is a multi-tile PCIe retimer, the method further comprising receiving the PCIe data stream over one or more lanes coupled to a leader tile of the multi-tile retimer.

29. The method of claim 16, wherein the data package is a firmware update data package, and wherein the firmware update data package contains at least one vendor-defined instruction definition associated with an in-band retimer message.

30. (canceled)
